(19) United States
(12) Patent Application Publication
(10) Pub. No.: US 2006/0229912 A1
(43) Pub. Date: Oct. 12, 2006

(54) Beauty information providing system

(75) Inventors: Shuji Negishi, Shinagawa-Ku (JP); Takanori Takahashi, Shinagawa-Ku (JP); Yoshikazu Hirai, Yokohama-Shi (JP); Fukuyoshi Mori, Yokohama-Shi (JP)

Correspondence Address: BURR & BROWN, PO BOX 7068, SYRACUSE, NY, 13261-7068, US

(73) Assignee: Pola Chemical Industries Inc., Shizuoka-Shi (JP)

(21) Appl. No.: 11/398,417

(22) Filed: Apr. 5, 2006

(30) Foreign Application Priority Data
Apr. 7, 2005 (JP) 2005-111402

(51) Int. Cl. G06Q 10/00; G06Q 50/00

(52) U.S. Cl. 705/2

(57) ABSTRACT

A beauty information providing system, includes: a first computer used in counseling of a customer who visits a merchandise store; a second computer used in counseling of a customer who visits an aesthetic treatment salon; a server connected to the first and second computers via communication networks; evaluation result creating unit which creates results of evaluating a customer's skin based on at least results of analysis on images of corneocytes collected from the customer's skin, results of analysis on enlarged images of the customer's skin, and the customer's answers to a skin evaluation questionnaire; and screen data creating unit which creates screen data for showing the evaluation results, screen data for showing skin care advice suited to the evaluation results, and screen data for showing an aesthetic treatment recipe suited to the evaluation results.

### BACKGROUND OF THE INVENTION

1. Field of the invention

The present invention relates to a system useful for managing a customer's skin information comprehensively and for selecting appropriate treatment courses and cosmetics with efficiency in providing beauty (aesthetic) treatment and selling cosmetics.

2. Description of the Related Art

Cosmetics are indispensable for keeping skin healthy and youthful. However, cosmetics can impair the health of their user's skin when they are poorly chosen and do not agree with the user's skin properties. In addition, the diversified effects and potencies of cosmetics owing to the advances in many fields of science necessitate a skill in selecting cosmetics and make it difficult for customers to choose appropriate cosmetics.

Against this background, various principles for selecting cosmetics have been devised. As a potent tool in selection of cosmetics, there is a technique of estimating the skin condition by measuring the shape of a horny layer cell collected from facial skin. Cosmetic selection techniques to which this skin condition estimating technique is applied have also been developed (see Patent documents 1 to 12, for example).

The same circumstance applies to aesthetic treatment (beauty treatment) which is expected to work on the whole body. In aesthetic treatment, there are treatment methods to select in addition to cosmetics serving as media. Known techniques of selecting aesthetic treatment or cosmetics for the treatment are methods of choosing treatment specifics or cosmetics based on a questionnaire and observations of the skin condition (see Patent documents 13 to 24, for example).

Some of such methods of managing a customer's skin information for individual purposes with the use of a computer or the like have been known (see Patent documents 25 to 27, for example) However, there has been no computer system at all that executes a skin evaluation usable in determining specifics of aesthetic treatment as well as selecting appropriate cosmetics and that presents the result of the evaluation.

[Patent document 1] JP 2004-105700 A

[Patent document 2] JP 2004-053491 A

[Patent document 3] JP 2003-315331 A

[Patent document 4] JP 2003-202336 A

[Patent document 5] JP 2003-199727 A

[Patent document 6] JP 2002-017688 A

[Patent document 7] JP 2001-116745 A

[Patent document 8] JP 2001-108674 A

[Patent document 9] JP 2001-013138 A

[Patent document 10] JP 2000-12038 A

[Patent document 11] JP 2000-12037 A

[Patent document 12] JP 2000-12036 A

[Patent document 13] JP 2004-229905 A

[Patent document 14] JP 2004-219632 A

[Patent document 15] JP 2004-216011 A

[Patent document 16] JP 2004-203806 A

[Patent document 17] JP 2004-203805 A

[Patent document 18] JP 2004-113527 A

[Patent document 19] JP 2004-105479 A

[Patent document 20] JP 2003-290167 A

[Patent document 21] JP 2003-250805 A

[Patent document 22] JP 2002-207421 A

[Patent document 23] JP 2002-207420 A

[Patent document 24] JP 2002-204718 A

[Patent document 25] JP 2003-036308 A

[Patent document 26] JP 2002-222337 A

[Patent document 27] JP 2002-056281 A

### SUMMARY OF THE INVENTION

An object of the present invention is to provide a technique of providing information for efficiently selecting cosmetics and the like at merchandise stores and of providing suitable beauty treatment specifics at beauty treatment salons.

The present invention provides a beauty information providing system, including:

a first computer used in counseling of a customer who visits a merchandise store to sell goods including cosmetics;

a second computer used in counseling of a customer who visits an aesthetic treatment salon;

a server connected to the first and second computers via communication networks;

an evaluation result creating unit which creates results of evaluating a customer s skin based on at least results of analysis on images of corneocytes collected from the customer's skin, results of analysis on enlarged images of the customer's skin, and the customer's answers to a skin evaluation questionnaire; and

a screen data creating unit which creates screen data for showing the evaluation results, screen data for showing skin care advice suited to the evaluation results, and screen data for showing an aesthetic treatment recipe suited to the evaluation results,

in which the first computer has a display control unit, which displays on a display device screens based on screen data for showing skin evaluation results of a customer who visits the merchandise store and screen data for showing skin care advice, the screen data being created by the screen data creating unit,

in which the second computer has a display control unit, which displays on a display device screens based on screen data for showing skin evaluation results of a customer who visits the aesthetic treatment salon, screen data for showing skin care advice, and screen data for showing an aesthetic treatment recipe, the screen data being created by the screen data creating unit, and

in which the server has a storage unit to store a customer database, which holds at least the evaluation results and the aesthetic treatment recipe as items to store.

The present invention may be configured such that, in the case where past evaluation results of a customer are stored in the customer database, the evaluation result creating unit creates, for the customer, skin evaluation results on which the past evaluation results are reflected.

The present invention may be configured such that a sales facility, which includes a first area used as the merchandise store, a second area used as the aesthetic treatment salon, and a third area placed between the first area and the second area to be shared between the merchandise store and the aesthetic treatment salon is further included,

in which the first area and the second area are provided with entrances from the outside that are independent of each other,

in which the third area is provided with an entrance leading to the first area and an entrance leading to the second area,

in which the first computer is placed in the first area,

in which the second computer is placed in the second area, and

in which a third computer connected to the first and second computers via communication networks are placed in the third area to create image data of corneocytes collected from a customer and analyze the corneocytes based on the image data.

The present invention may be configured such that the evaluation result creating unit and the screen data creating means are placed in the server, and

in which the server provides the screen data upon request from the first computer or from the second computer.

According to the present invention, information for efficiently selecting cosmetics and the like can be provided at merchandise stores and suitable beauty treatment specifics can be provided at beauty treatment salons.

### BRIEF DESCRIPTION OF THE DRAWINGS

FIG. 1 is a diagram showing a configuration example of a system for selling merchandise and providing aesthetic treatment;

FIG. 2 is a diagram showing a detailed configuration of the system illustrated in FIG. 1;

FIG. 3 is a transition diagram of screens (pages) displayed by a personal computer (PC) that is placed in a second area (an aesthetic treatment salon) shown in FIGS. 1 and 2, the diagram showing a screen transition during a customer's first visit;

FIG. 4 is a transition diagram of screens displayed by a PC that is placed in the second area (the aesthetic treatment salon) shown in FIGS. 1 and 2, the diagram showing a screen transition during a customer's second or subsequent visit;

FIG. 5 is a diagram showing a display example of a language selecting screen;

FIG. 6 is a diagram showing a display example of a system description (skin check) screen for the aesthetic treatment providing service;

FIG. 7 is a diagram showing a display example of a system description (aesthetic treatment recipe) screen for the aesthetic treatment providing service;

FIG. 8 is a diagram showing a display example of a course selecting screen for the aesthetic treatment providing service;

FIG. 9 is a diagram showing a display example of a screen for displaying a questionnaire (Questionnaire One) to be answered by a customer;

FIG. 10 is a diagram showing a display example of a screen for displaying “skin score”;

FIG. 11 is a diagram showing a display example of a screen for displaying “overall skin chart”;

FIG. 12 is a diagram showing a display example of a screen for displaying “hydration retaining ability”;

FIG. 13 is a diagram showing a display example of a screen for displaying “discolorations (status of discoloration)”;

FIG. 14 is a diagram showing a display example of a screen for displaying “skin rhythm”;

FIG. 15 is a diagram showing a display example of a screen for displaying “home care advice (skin care advice)”;

FIG. 16 is a diagram showing a display example of a screen for displaying “aesthetic treatment recipe”;

FIG. 17 is a transition diagram of screens displayed by a PC that is placed in a first area (a merchandise store) shown in FIGS. 1 and 2, the diagram showing a screen transition during a customer's first coming; and

FIG. 18 is a transition diagram of screens displayed by a PC that is placed in the first area (the merchandise store) shown in FIGS. 1 and 2, the diagram showing a screen transition during a customer's second or subsequent visit.

### DETAILED DESCRIPTION OF THE PREFERRED EMBODIMENTS

An embodiment of the present invention will be described below with reference to drawings. The configurations of the following embodiment are given as examples, and do not limit the present invention.

[System Configuration]

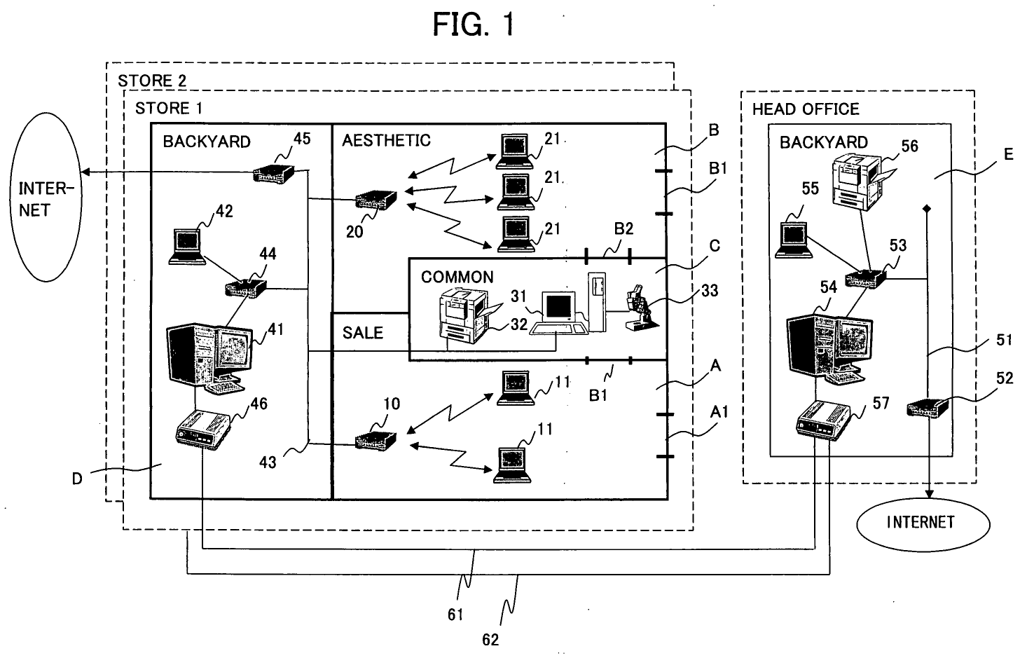

FIG. 1 is a diagram showing a configuration example of a system for selling cosmetics and providing beauty (aesthetic) treatment. A business organization (company) that sells cosmetics and provides aesthetic treatment has, as shown in FIG. 1, a head office facility and plural store facilities (Store 1 and Store 2 are shown in FIG. 1 as examples). The head office is connected to the store facilities via communication lines.

Each store facility is structured as described below, and the description takes the Store 1 as an example. the Store 1 has a first area A, which serves as a merchandise store to sell cosmetics and other similar articles (merchandise), a second area B, which serves as an aesthetic treatment salon to provide aesthetic treatment, a common area C, which is shared by the merchandise store and the aesthetic salon, and a backyard area D.

The first area A and the second area B are provided with separate entrances A1 and B1, respectively: a customer who wants to purchase cosmetics uses the entrance A1 to enter and exit the merchandise store whereas a customer who wants to receive aesthetic treatment uses the entrance B1 to enter and exit the aesthetic treatment salon.

The common area (common space) C is used as an evaluation room where horny layer cells (corneocytes) of customers who visit the merchandise store (the first area A) and customers who visit the aesthetic treatment salon (the second area B) are evaluated. The common area C is provided with an entrance A2, which leads to the first area A, and an entrance B2, which leads to the second area B.

The backyard area D is a space to place a server for providing information via communication lines to PCs (personal computers) that are installed in the first area A and the second area B in order to attend to customers, and for collecting information from the PCs set in the first area A and the second area B and from a PC set in the common area C; an information processing apparatus such as a PC for maintaining the server; and a communication equipment.

The Store 1 is provided with the following information equipments and communication networks that connect the information equipments to one another. Placed in the first area A are a radio LAN (Local Area Network) receiver (called an access point) 10 and one or more PCs 11 (FIG. 1 shows as examples two PCs: first computers) which use a wireless LAN for wireless communications with the radio LAN receiver 10.

As in the first area A, placed in the second area B are a radio LAN receiver 20 and one or more PCs 21 (FIG. 1 shows as examples three PCs: second computers) which use a wireless LAN for wireless communications with the radio LAN receiver 20.

Placed in the common area C are a PC 31 (third computer) for analyzing customers' skin, and a printer 32. The PC 31 is connected to a microscope 33, and an image taken by the microscope 33 is fed into the PC 31.

Placed in the backyard area D are a server 41 and a PC 42 used for maintenance of the server 41. The radio LAN receiver 10, the radio LAN receiver 20, the PC 31 and the printer 32 are connected to one another through a LAN (wired LAN) 43. The server 41 and the PC 42 are connected to the LAN 43 via a HUB 44.

The LAN 43 further contains an ADSL router (Asymmetric Digital Subscriber Line router) 45 connected to the Internet. The server 41 is connected via a TA (Terminal Adapter with DSU (Data Signal Unit)) 46 to a communication line (ISDN (Integrated Service Digital Network) line) 61.

The head office has a backyard area E. An ADSL router 52 and a HUB 53, which are connected by a LAN 51, are placed in the backyard area E. The ADSL router 52 is connected to the Internet. Connected to the HUB 53 are a server 54, a PC 55 for maintenance of the server 54, and a printer 56. The server 54 is connected via a TA 57 to ISDN lines 61 and 62, which connect the TA 57 with the TA 46 placed in Shop One and Shop Two each.

The merchandise store and the aesthetic treatment salon respectively offer counseling to customers who visit there. In the process of counseling, a customer s skin is analyzed and evaluated based on the result of the analysis. The result of the skin evaluation is presented to the customer.

The merchandise store suggests cosmetics and other merchandise to the customer in accordance with the result of the skin evaluation. The customer can improve his/her skin by purchasing and using the recommended items. In the aesthetic treatment salon, an aesthetic treatment recipe (menu) is created in accordance with the result of the skin evaluation, and presented to the customer. Then the customer receives aesthetic treatment (massage or the like) following the recipe. The customer can thus improve his/her skin.

The customer's skin evaluation result is managed by the store facility. When skin analysis and evaluation are performed again on the customer's second or subsequent visit to the store, the new evaluation result can be compared with the old evaluation result. This enables the customer to see an improvement of the skin objectively.

The system shown in FIG. 1 is used to analyze and evaluate a customer's skin, obtain and manage customer information (e.g., information on the customer's attributes (personal information) and skin evaluation results of the customer), and the like at the store facility. The PCs 11 and 21 are used as terminal devices for attending to customers (counseling). The PCs 11 and 21 are used as terminal devices for showing a counseling-related screen to a customer and for entering the customer's attributes information and information for evaluating the customer's skin.

The PC 31 is used to perform, as one of elements constituting a customer's skin analysis, an analysis of the customer's horny layer cells and the like.

The server 41 responds to requests sent via networks (the LAN 43 and the wireless LANs) from the PCs 11 and 21 by providing counseling screen information in accordance with the progress (in steps) of counseling. The server 41 also executes skin evaluation processing based on analysis results, evaluation results, and skin evaluation material data which are received via networks from the PCs 11, 21 and 31. Furthermore, the server 41 accumulates, as customer information, information obtained about individual customers from the PCs 11 and 21 such as the customers' attributes information, skin evaluation material data, and evaluation results, and manages the customer information.

The server 54 collects and accumulates customer information accumulated in each server 41. This way, customer information of every store can be managed at the head office in a centralized manner. The server 54 can provide customer information to any server 41 upon request from the server 41.

[System Configuration Details]

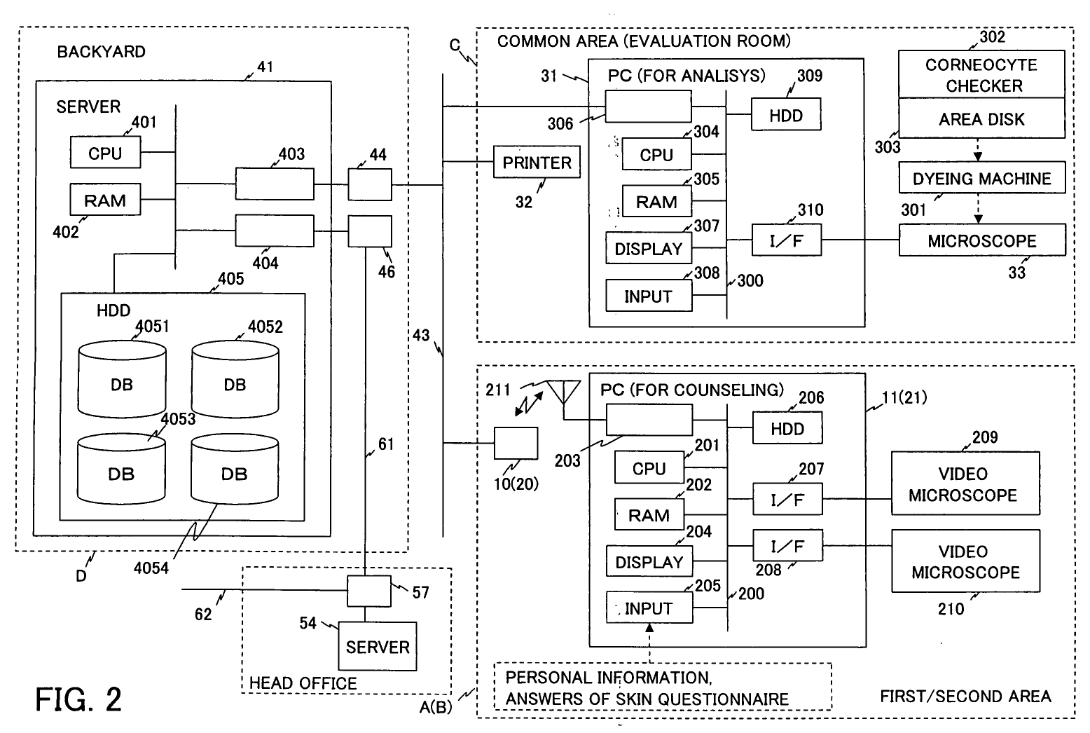

FIG. 2 is a configuration diagram showing details of the system that is illustrated in FIG. 1. The configuration in the first/second area A, B, the common area C and the backyard area D will individually be described below.

<First/Second Area>

The first area A and the second area B have the same configuration. Therefore, the second area B will be described exemplarily. The PC 21 for counseling set in the second area B has a CPU (Central Processing Unit) 201, a RAM (Random Access Memory) 202, a communication module 203, an input device 204, a display device 205 and a hard disk drive (HDD, including a hard disk (HD)) 206, which are interconnected via a bus 200, and interface devices (I/Fs) 207 and 208.

The I/F 207 is connected to a video microscope 209 for taking a skin texture image. The I/F 208 is connected to a video microscope 210 for taking a discoloration image.

The input device 205 is composed of a keyboard, a pointing device such as a mouse, and other components. The input device 205 is used by an operator of the PC 21 to enter information. Entered as input information are personal information of customers, answers to a questionnaire about skin, and the like.

The display device 205 has a display screen on which various types of information is displayed. The display device 205 displays various counseling-related screens based on screen data, which is provided by the server 41.

The RAM 202 is used as a work area of the CPU 201. The RAM 202 temporarily stores programs and data used by the CPU 201. The communication module 203 converts data to be transmitted into a radio signal and sends the signal from an antenna 211. A radio signal received through the antenna 211 is converted into data by the communication module 203. The HD in the HDD 206 stores, as storage means, programs executed by the CPU 201 and data used in execution of the programs.

The video microscope 209 takes a magnified (×30) skin (cheek) image for analysis of the fineness (texture) of a customer's (subject's) skin, and sends a color image signal obtained by the shooting to the PC 21. The video microscope 210 takes a magnified (×5) skin (cheek) image for analysis of discolorations of a customer's (subject's) skin, and sends a color image signal (RGB signal) obtained by the shooting to the PC 21.

The CPU 201 function as control means, and loads programs stored in the HD in the HDD 206 onto the RAM 202 to execute the programs. The CPU 201 implements at least the following functions by executing the programs.

(a) The CPU 201 reads a color image signal that the video microscope 209 sends, to thereby create, from the signal, image data (image data of texture image).

(b) The CPU 201 reads a color image signal that the video microscope 210 sends, to thereby create, from the signal, image data (data of the original image) and data of a B channel image, which is an image obtained by extracting a B channel alone from the original image.

The CPU 201 creates the B channel image (image of blue light peaked at 435.8 [nm] in principle) as an image for analysis of discolorations. The B channel image is known to be useful for detection of melanin granules in horny layer cells. A conventional way to observe melanin, which causes discolorations, is to prepare a sample by collecting horny layer cells from a subject's skin and dyeing the cells with silver nitrate and gentian violet, and then observing the sample through a microscope (see JP 2000-12037 A) In this embodiment, sample preparation for melanin observation is omitted by creating a B channel image with the use of the video microscope 210. Thus a result of discolorations analysis can be obtained in a shortened period of time.

(c) The CPU 201 receives input information which is entered in the PC 21 via the input device 205 and which is constituted of information of a customer's attributes (personal information: name, age, address, customer identification information (customer ID), etc.) and answers to a questionnaire about skin (skin questionnaire).

(d) The CPU 201 sends a horny layer evaluation request containing a customer ID to the analyzing PC 31 via networks (the wireless LANs and the LAN 43).

(e) The CPU 201 sends image data of a texture image, image data of an original image, and image data of a B channel image (hereinafter, an original image and its B channel image may collectively be referred to as “discoloration image”) to the analyzing PC 31 via networks (the wireless LANs and the LAN 43). These pieces of image data are sent, as an evaluation request, along with a customer ID, to the PC 31.

(f) The CPU 201 sends input information such as attributes information and answers to a skin questionnaire to the server 41 via a network.

(g) The CPU 201 receives counseling screen data from the server 41 via a network, and displays on the display device 205 a screen in accordance with the received screen data (display control means).

If a video microscope employed is of variable power type, the system needs only one video microscope.

<Common Area (Evaluation Room)>

The analyzing PC 31, the microscope 33 connected to the PC 31, and the printer 32 are set up in the common area C. Also installed in the common area C is a corneocyte dyeing (staining) machine 301, which is a device for dyeing horny layer cells collected from a customer in order to analyze the way horny layer cells peel and the degree of completion of the stratum corneum.

The horny layer cells can be obtained from a customer's cheek by stripping with the use of an adhesive member. Employable as the adhesive member is a known corneocyte checker (a piece of transparent adhesive tape such as Scotch tape) 302, an area disk (an adhesive disk obtained by applying an adhesive to a polyethylene terephthalate plate) 303, or the like. The collected horny layer cells are dyed by the corneocyte dyeing machine 301, and a horny layer cell sample (corneocytes specimen) is created from the dyed horny layer cells.

For example, a horny layer cell dyeing method and a horny layer cell sample preparing method that have been disclosed in JP 2003-202336 A are applicable to the staining of horny layer cells and the preparation of a horny layer cell sample (corneocytes specimen). The prepared horny layer cell sample can be used for one, or more than one, measurement or discerning process selected from measurement of a size of a horny layer cell, the presence or absence of a nucleated cell, the frequency of appearance of nucleated cells, the regularity in arrangement of horny layer cells, the shape of a horny layer cell, and the way horny layer cells peel (roughness of a surface of horny layer).

The microscope 33 shows an enlarged view of the horny layer cell sample set therein at a desired magnification power. In this example, the horny layer cell sample receives ×30 magnification for evaluation of the way horny layer cells peel (TA) and receives ×150 magnification for evaluation of the degree of completion of the horny layer (the regularity in arrangement of horny layer cells/the shape of a horny layer cell). The microscope 33 is equipped with an image pickup device such as a CCD (charge-coupled device). Each enlarged color image (horny layer cell image (hereinafter simply referred to as “horny layer image”) taken by the image pickup device is sent to the PC 31 via a signal line.

The PC 31 has a CPU 304, a RAM 305, a communication module 306, an input device 308, a display device 307 and an HDD (including an HD) 309, which are interconnected via a bus 300, and an I/F 310. The I/F 310 is connected to the microscope 33 via a signal line.

The CPU 304 loads programs stored in the HD within the HDD 309 onto the RAM 305 and executes the programs to thereby implement, as control means, the following functions.

(A) The CPU 304 responds to evaluation requests made by the PCs 11 and 21 by reading enlarged horny layer images (output signals of the image pickup device) from the microscope 33 and creating data of these images (a horny layer image (TA) and a horny layer image (the degree of completion)).

(B) The CPU 304 measures the size of a horny layer cell (corneocyte) using one of the two horny layer images (×30 horny layer image). As measuring means, the CPU 304 binarizes the horny layer image into black and white. The horny layer image is thus divided into one or more black portions (dyed corneocytes) and a white portion (the background (undyed portion)). The pixel count in each of the black portions (corneocytes) is counted to calculate the size of a horny layer cell from the pixel count. This area measurement is performed on two or more horny layer cells in the horny layer image to measure the mean value of the size (average size) and the area measurement cell count.

(C) The CPU 304 performs processing of evaluating the way horny layer cells peel (TA). The CPU 304 displays on the display device 307 the measured mean size value and size measurement cell count and the horny layer image (×30). An evaluator consults the displayed mean size value, size measurement cell count, and horny layer image (×30) to make an evaluation in, for example, five levels. A numerical value indicating the result of the evaluation is entered through the input device 308.

(D) The CPU 304 performs processing of evaluating the degree of completion of the horny layer. The CPU 304 displays on the display device 307 the other of the two horny layer images (×150 horny layer image). An evaluator consults the displayed horny layer image (×150) to make an evaluation in, for example, five levels. A numerical value indicating the result of the evaluation is entered through the input device 308.

(E) The CPU 304 performs, upon request from the PCs 11 and 21, processing of evaluating the skin texture and skin discolorations using a texture image and a discoloration image (an original image and its B channel image) which are received from each of the PCs 11 and 21 via networks. The CPU 304 displays on the display device 307 the texture image, the original image, and the B channel image. An evaluator consults the displayed texture image, original image, and B channel image to make an evaluation for the skin texture and skin discoloration, for example, in five levels. Numerical values indicating the results of the skin texture evaluation and the skin discoloration evaluation are entered through the input device 308.

(F) The CPU 304 sends, to the server 41, via a network (the LAN 43), the horny layer images, the texture image, the discoloration image, the mean size value, the size measurement cell count, the horny layer evaluation results (TA and the degree of completion), and the skin texture and discoloration evaluation results. The CPU 304 causes the communication module 306 to send the images, the mean size value, the size measurement cell count, TA, the degree of completion, and numerical values indicating the skin texture and discoloration evaluation results to the server 41 as evaluation result information along with a customer ID.

<Backyard Area>

The server 41 set in the backyard area D has a CPU 401, a RAM 402, communication modules 403 and 404 and an HDD (including an HD) 405, which are interconnected via a bus 400. The communication module 403 is connected to the HUB 44, and handles processing of exchanging data with the PCs 11, 21 and 31. The communication module 404 is connected to the TA 46, and handles processing of exchanging data with the head office server 54.

The HD within the HDD 405 stores a customer database (DB) 4051, a screen data DB 4052 and an evaluation material data DB 4053. The customer DB 4051 stores customer information (information on a customer's attributes, answers to a skin questionnaire, horny layer images (×30 and ×150), a texture image, an original image, a B channel image, TA, the degree of completion, numerical values indicating texture and discoloration evaluation results, etc.) in association with a customer ID and the name and birth date of the customer.

The screen data DB 4052 stores counseling screen data provided to the PCs 11 and 21. Screen data can be created from, for example, an HTML (HyperText Markup Language) file. The screen data DB 4052 stores, in addition to an HTML file, image data to be inserted onto a Web page that is created in accordance with the HTML file, and text data (e.g., comments on the evaluation results) to be selectively displayed on the Web page. Image data stored in the customer DB 4051 is used as one of images to be inserted onto a Web page that is created in accordance with an HTML file. Image data is stored in the customer DB 4051 in association with a relevant HTML file.

The evaluation material data DB 4053 stores data for calculating results of a customer's skin evaluation. In this embodiment, a five-level evaluation is performed to produce a skin evaluation result about each of six items, “hydration retaining ability”, “oiliness (sebum)”, “susceptibility to pimples”, “discolorations”, “wrinkles/skin texture” and “sensitivity”. This embodiment is structured such that individual evaluations are made on five more items, “hydration retaining ability”, “protecting ability of stratum corneum”, “wrinkles/skin texture”, “status of discoloration” and “sensitivity”.

Employed as “hydration retaining ability”, “protecting ability of stratum corneum”, “wrinkles/skin texture” and “status of discoloration” are the way horny layer cells peel (TA), the degree of completion of horny layer cells, and numerical values indicating results of texture image and discoloration image evaluation which are obtained by the PC 31 in the common area C (evaluation room).

Employed as “hydration retaining ability”, “status of discoloration” and “wrinkles/skin texture” are numerical values of evaluation results obtained by the PC 31. On the other hand, “oiliness (sebum)”, “susceptibility to pimples” and “sensitivity” are evaluated based on answers to a skin questionnaire. The skin questionnaire includes questions for evaluating “oiliness (sebum)”, “susceptibility to pimples” and “sensitivity”.

The evaluation material data DB 4052 stores a table that holds numerical values associated with patterns of answers to the questions for evaluating “oiliness (sebum)”, “susceptibility to pimples” and “sensitivity” (not shown), and is constituted so that a numerical value corresponding to an answer pattern is determined as an evaluation result.

Furthermore, in this embodiment, “skin score”, which is an overall evaluation of a customer's skin, is presented to the customer as one of evaluation results. “Skin score” is rated out of 100 points. The evaluation material data DB 4052 stores data for calculating “skins core”. For instance, when the sum of numerical values indicating evaluation results of “(1) hydration retaining ability”, “(2) protecting ability of stratum corneum”, “(3) wrinkles/skin texture”, “(4) discolorations” and “(5) sensitivity/factors” is multiplied by 2 and the product is employed as “skin score”, the evaluation material data DB 4052 stores data of a calculation expression “((1)+(2)+(3)+(4)+(5))×2=skin score”.

The CPU 401 loads programs stored in the HD within the HDD 405 onto the RAM 402 and executes the programs to thereby implement, as control means, the following functions.

(I) The CPU 401 performs processing of evaluating a customer's skin (evaluation result creating means). The evaluation processing is executed in, for example, the following steps.

(ST1) The CPU 401 receives, at the communication module 403, a customer's attributes information and answers to a skin questionnaire which are sent from each of the PCs 11 and 21, and stores the received data in the customer DB 4051.

(ST2) The CPU 401 receives, at the communication module 403, images, a mean size value, a measurement cell count, and numerical values indicating evaluation results which are sent from the PC 31, and stores the received data in the customer DB 4051.

(ST3) The CPU 401 determines the way horny layer cells peel (TA),the degree of completion of horny layer cells, and numerical values indicating texture image and discoloration image evaluation results as numerical values indicating evaluation results of “hydration retaining ability”, “protecting ability of stratum corneum”, “wrinkles/skin texture” and “status of discoloration”.

(ST4) The CPU 401 reads, out of the evaluation material data DB 4053, numerical values of “oiliness (sebum)”, “susceptibility to pimples” and “sensitivity” which correspond to answers to a skin questionnaire, and determines the read values as numerical values indicating evaluation results.

(ST5) The CPU 401 calculates “skin score” from the determined numerical values of evaluation results and the “skin score” calculation expression stored in the evaluation material data DB 4053. The CPU 401 stores the determined evaluation results and skin score in the customer DB 4051 as one element of customer information.

(ST6) The CPU 401 creates, upon request from the PCs 11 and 21, relevant screen data (an HTML file) from data stored in the screen data DB 4052, and causes the communication module 403 to send the created screen data to the PC that has made the request.

(II) The CPU 401 also creates screen data in accordance with a request from the PCs 11 and 21 (a screen providing request) and provides the created screen data (screen data creating means) Some of screens (Web pages) provided to the PCs 11 and 21 are fixed screens, on which always the same contents are displayed, and others are variable screens, on which displayed contents change from time to time. What are displayed on variable screens include a customer's attributes information, an image taken for each customer, evaluation results, and comments (text) on evaluation results.

Upon reception of a request to provide a fixed screen, the CPU 401 reads, out of the screen data DB 4052, screen data of the requested fixed screen, and sends the read data to the PC that has made the request. Upon reception of a request to provide a variable screen, on the other hand, the CPU 401 reads, out of the screen data DB 4052, screen data (an HTML file) that constitutes a base, and suitably edits text and image link information in the HTML file to create screen data of a variable screen containing desired display contents. The created screen data is sent to the PC that has made the request (the processing in ST6 described above) Text data for editing is stored in the screen data DB 4052.

(III) The CPU 401 also stores, as customer information, in the customer DB 4051, information received from the PCs 11, 21 and 31 about customers (attributes information, answers to a skin questionnaire, skin-related images, evaluation results). Customer information of each customer is associated with a customer ID upon storage, so that the customer information can be retrieved using the customer ID as a search key.

(IV) Furthermore, the CPU 401 sends customer information accumulated in the customer DB 4051 to the server 54 in response to a request from the server 54 or through voluntary processing. The CPU 401 downloads necessary customer information from the server 54 as the need arises.

[Counseling]

Described next is counseling conducted in the merchandise store and in the aesthetic treatment salon with the use of the system shown in FIGS. 1 and 2.

<Aesthetic Treatment Salon>

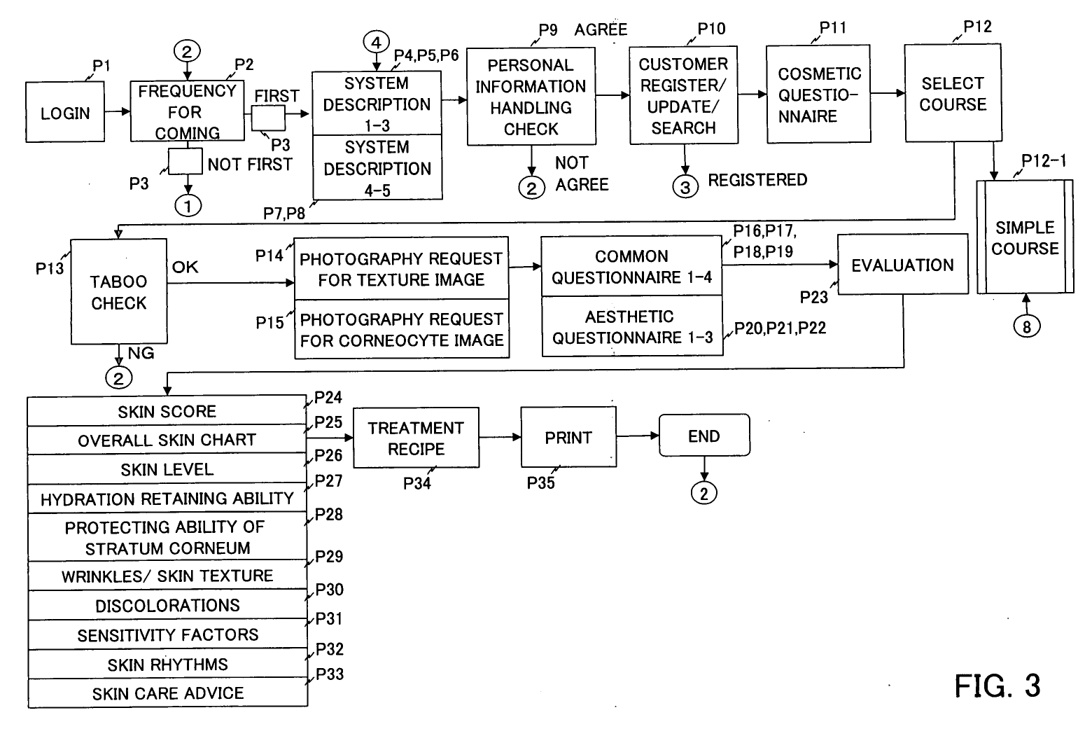

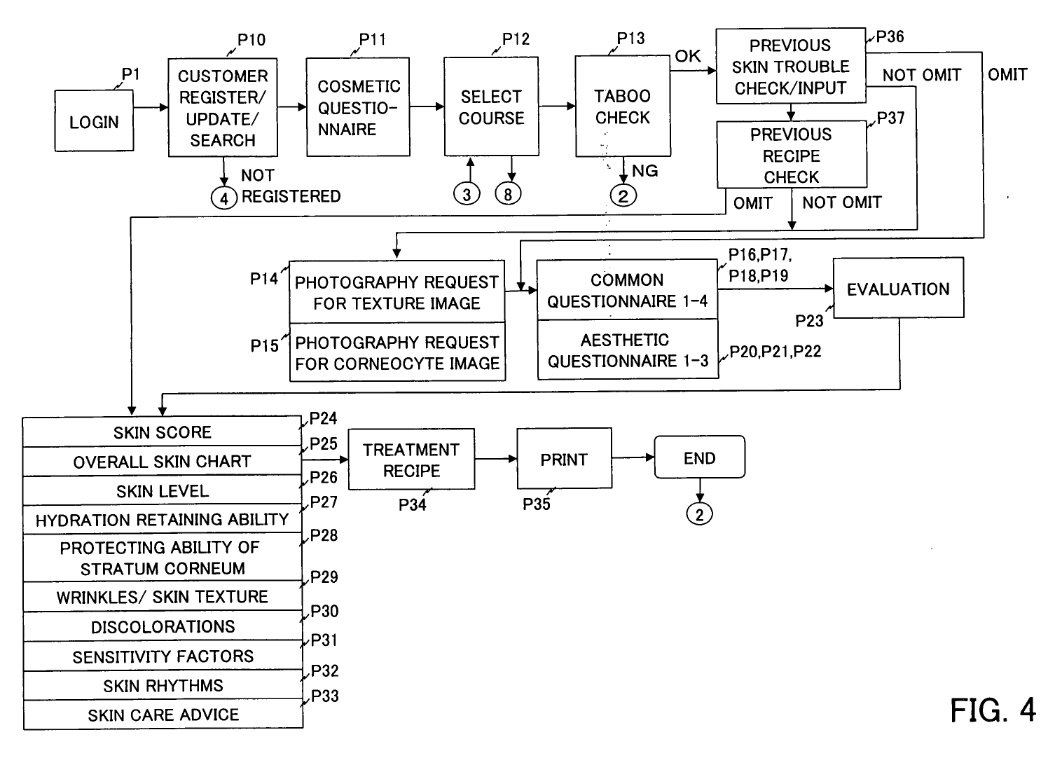

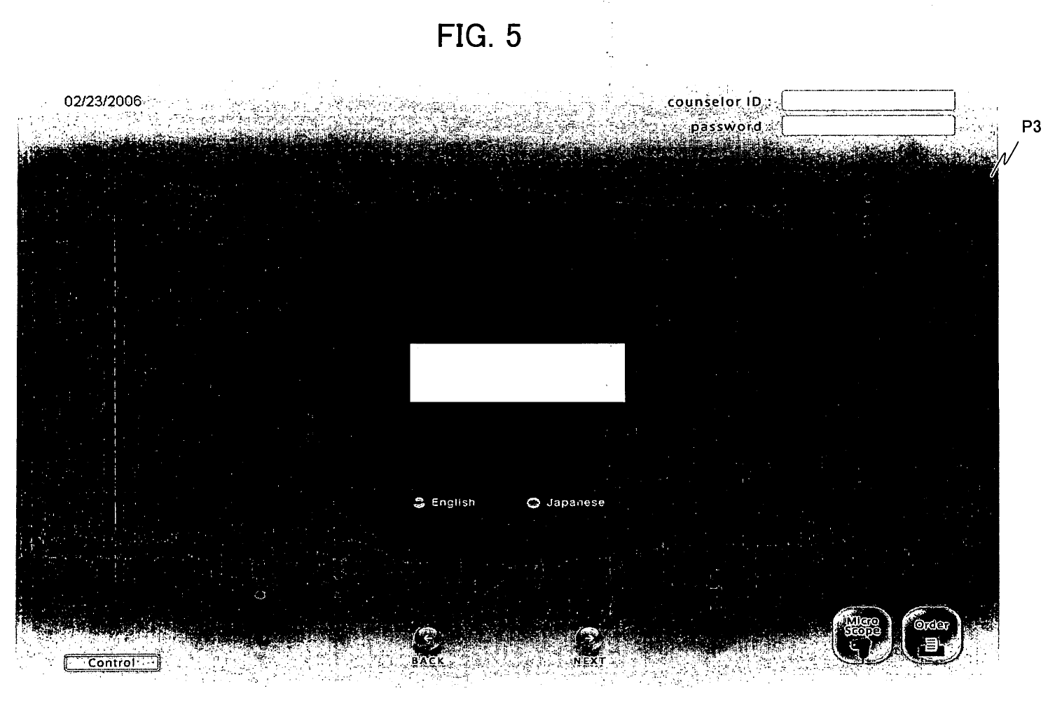

FIG. 3 is a screen transition diagram of screens presented to a customer who visits the aesthetic treatment salon for the first time. FIG. 4 is a screen transition diagram of screens presented to a customer on his/her second or subsequent visit to the aesthetic treatment salon. FIGS. 5 to 16 are diagrams showing screen display examples. Each screen is displayed on the display screen of the display device 204 of the PC 21.

To display a counseling screen on the display device 204 of the PC 21, the PC 21 executes processing of sending a request for desired screen data (screen providing request) to the server 41, processing of receiving, from the server 41, screen data that is sent in accordance with the screen providing request, and processing of displaying on the display device 204 a screen based on the screen data. These data transmission/reception processing and processing for displaying a screen will be omitted from the following description.

<<First Visit>>

To start counseling of a customer in FIG. 3, execution of a counseling assisting program, which is stored in the HD of the PC 21, is started. This causes the display device 204 to display a login screen P1. A given item is entered on the login screen P1, and the login screen P1 is switched to a first time/second time or more selecting screen (screen P2).

Information indicating that it is a first visit is entered on the screen P2 in the case where the customer has never visited the salon before, and information indicating that it is a second or subsequent visit is entered on the screen P2 in the case where the customer has been to the salon once previously. The premise here is that information indicating a first visit is entered.

This replaces the screen P2 with a screen P3. The screen P3 is, as shown in FIG. 5, a screen for selecting a language to be displayed on screens from Japanese and English. The language desired by the customer is chosen and entered as instructed on the screen P3. Screen data written in Japanese and screen data written in English are stored in the screen data DB 4052 of the server 41, and, in the subsequent steps, a screen providing request in the language chosen on the screen P3 is sent to the server 41.

After a language is chosen on the screen P3, the screen P3 is switched to a system description screen. The system description screen is a screen to display an overview of services provided at the aesthetic treatment salon, and is composed of five screens, P4, P5, P6, P7 and P8.

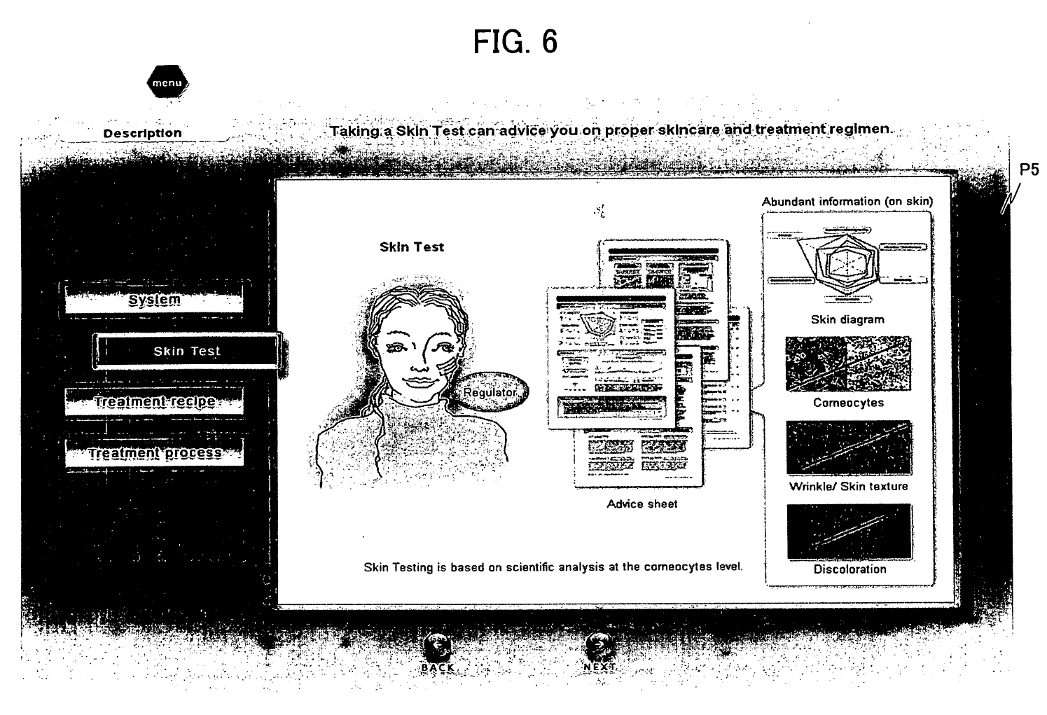

On the screen P4, programs a first time customer receives and programs a customer receives on a second or subsequent visit (revisit) are presented. The screen P5 displays, as shown in FIG. 6, the outline of skin analysis/evaluation (skin check) conducted in the process of a program in conjunction with counseling.

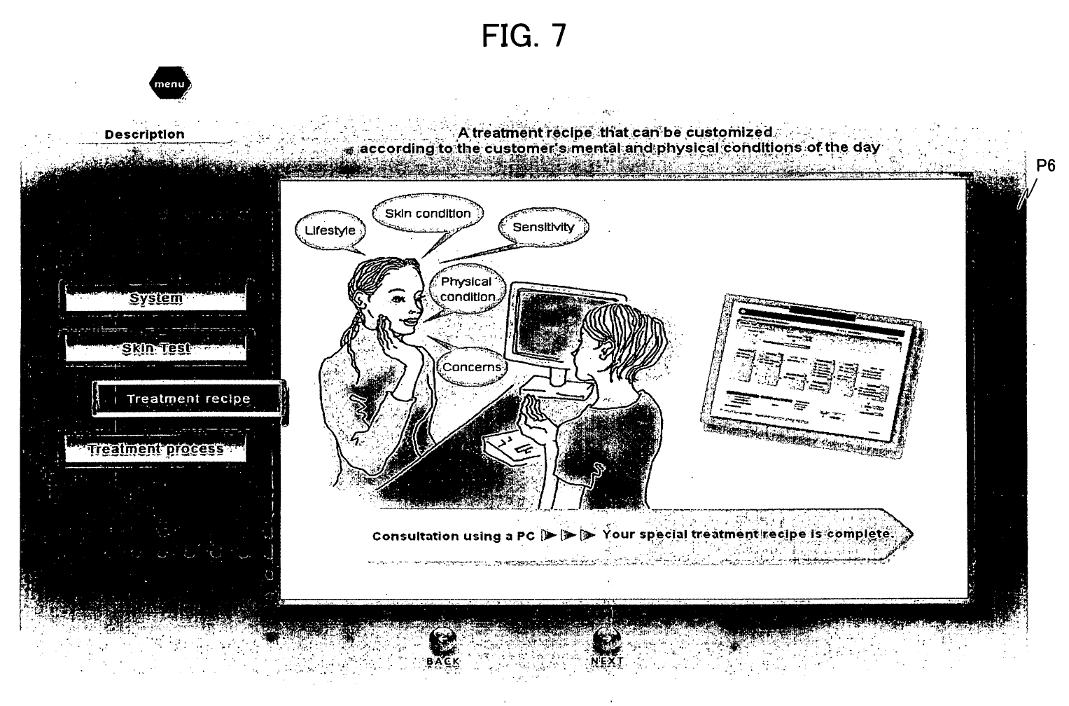

The screen P6 shows that, as illustrated in FIG. 7, a recipe of aesthetic treatment is created through counseling and a skin check in accordance with the customer's life style, skin condition, skin sensitivity, physical condition, skin troubles, and the like.

The screen P7 displays, along with an explanatory diagram, aesthetic treatment specifics (contents) in accordance with the recipe. The screen P8 displays information that a counseling session is started in order to create an advice sheet for the customer. After an input is made on the screen P8 prompting a shift to the next screen, the screen P8 is replaced with a screen P9.

The screen P9 displays an explanation about how the company handles customers' personal information, and asks the customer whether he/she consents to this privacy policy. In the case where the customer consents to the way the company handles personal information (in the case where consent is entered), the screen turns into a screen P10. On the other hand, when the customer does not agree with the privacy policy (when no consent is entered), the screen returns to the screen P2. In this case, subsequent services cannot be provided to the customer, and the counseling of the customer is ended at this point.

The screen P10 is a customer registration/update search screen. The screen P10 is used to newly register or update a customer's personal information (attributes information: name, birth date, gender, address, phone number, customer ID, etc.). The screen P10 has plural input fields where personal information is entered through the input device 205.

The screen P10 doubles as a personal information search screen. That is, having a search button for a customer ID and a search button for a customer s name and birth date, the screen P10 can be used to retrieve a customer's personal information with a customer ID or a name and a birth date as a key.

For instance, a customer who visits the aesthetic treatment salon for the first time may have been to the merchandise store and registered his/her personal information at the store. In another example, a customer who visits this particular branch for the first time may have already registered his/her personal information at another aesthetic treatment salon of the company.

The system is therefore given a personal information retrieval feature that uses a customer ID or a name and a birth date (in case a customer forgets the assigned customer ID) as a search key. With the press of one of the search buttons, a search request is sent from the PC 21 to the server 41. The server 41 searches the customer DB 4051 in accordance with the search request and, when personal information that is associated with the customer ID or the name and birth date is found, reads and sends this customer information to the PC 21.

When relevant personal information is not found in the customer DB 4051, the server 41 sends a search request to the server 54. The server 54 searches customer information accumulated in its own storage device for customer information that meets the search request. When relevant customer information is found, the server 54 sends this customer information to the server 41. On the customer DB 4051, the server 41 registers the customer information received from the server 54, and sends the personal information to the PC 21.

Receiving the personal information, the PC 21 displays the personal information in an appropriate place (input field) on the screen P10. Thus, once a customer registers his/her personal information in one out of all shops of the company, the information is available and repetition of input processing can be omitted.

When there is no response to a search request, the customer's personal information is deemed as unregistered, and is entered along with a newly assigned customer ID. Then the screen P10 is replaced with a screen P11 as a request for a shift to the next screen is entered. At this point, the entered personal information (including the customer ID) is sent to the server 41 and registered in the customer DB 4051.

The screen P11 displays a questionnaire about the use of cosmetics and aesthetic treatment. At an input of a request for a shift to the next screen after the customer's answers are entered, the screen P11 is replaced with a screen P12. The answers to the questionnaire are sent to the server 41 and registered in the customer DB 4051 as a part of customer information.

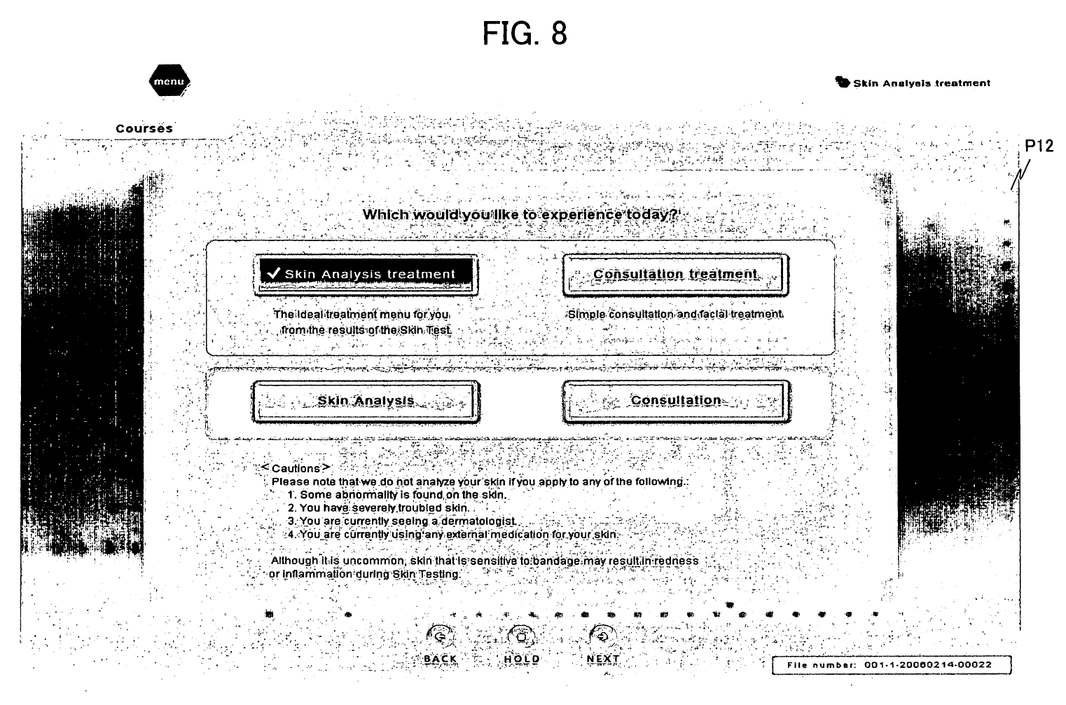

The screen P12 presents, as shown in FIG. 8, aesthetic treatment courses to ask the customer to select a course. There are a “skin analysis treatment” course and a “self-select (consultation)” course.

In the “skin analysis treatment” course, a skin check is conducted and a skin questionnaire is answered, results thereof are used to propose an aesthetic treatment menu (recipe) that is suitable for the customer, and aesthetic treatment is performed following the proposed recipe. The “self-select (consultation)” course is a simpler course in which a customer chooses a desired item on the menu of aesthetic treatment that the aesthetic treatment salon can provide, and receives treatment in accordance with the choice.

As shown in FIG. 8, there are course select buttons on the screen P12. When the customer presses a button for his/her desired course, the screen turns into the next screen. In the case where the “self-select (consultation)” course (the simple course) is chosen (by pressing the corresponding select button),the customer is presented with a screen for the simple course to select from the aesthetic treatment menu and treatment is carried out (FIG. 3, P12-1). On the other hand, in the case where a select button for the “skin analysis treatment” course is pressed, the screen P12 is replaced with a screen P13.

The screen P13 is a screen for checking taboos in aesthetic treatment. The screen P13 lists up causes that make aesthetic treatment impossible. In the case where a customer's condition matches one of the listed causes (NG), the customer cannot receive aesthetic treatment. Accordingly, counseling of the customer is ended at this point and the screen returns to the screen P2. On the other hand, in the case where a customer's condition does not match any of the listed causes (OK), the screen P13 is replaced with a screen P14 at an input of a request for a shift to the next screen.

Cued by the shift to the screen P14, shooting (photographing) of a texture image and a discoloration image is carried out. A computer program (software) for taking a texture image and a discoloration image is activated in the PC 21. Execution of the program causes the video microscopes 209 and 210 to take a texture image and a discoloration image. The screen P14 is replaced with a screen P15 as a request for a shift to the next screen is entered. At this point, an analysis request containing the texture image and the discoloration image is sent from the PC 21 to the PC 31.

The shift to the screen P15 is a cue to collect the customer's horny layer cells (corneocytes) with the use of the corneocyte checker (regulator) 302 and the area disk 303, and a horny layer cell sample (corneocyte specimen) is created. The horny layer cell sample is set in the microscope 33 placed in the common area C. The screen P15 has a horny layer cell evaluation requesting button. With the press of the evaluation requesting button, a request to take and evaluate a horny layer image is sent from the PC 21 to the PC 31. Receiving the shooting and evaluation request, the PC 31 reads an enlarged image of the horny layer cell sample set in the microscope 33, and executes analysis and evaluation of the horny layer using the enlarged image.

The press of the shooting and evaluation requesting button causes a shift from the screen P15 to the screen P16. The screen P16 and screens P17, P18, P19, P20, P21 and P22 are screens for presenting a skin questionnaire to a customer. The skin questionnaire is composed of plural questions presented through the screens P16 to P22. Questionnaires (Common Questionnaires One to Four) displayed on the screens P16 to P19 are common questionnaires presented to customers of the merchandise store and customers of the aesthetic treatment salon both. Questionnaires (Aesthetic Treatment Questionnaires One to Three) displayed on the screens P20 to P22 are aesthetic treatment salon-specific questionnaires presented only to customers of the aesthetic treatment salon. Questionnaire answers entered on the screens P16 to P22 are sent from the PC 21 to the server 41 and stored in the customer DB 4051 as customer information.

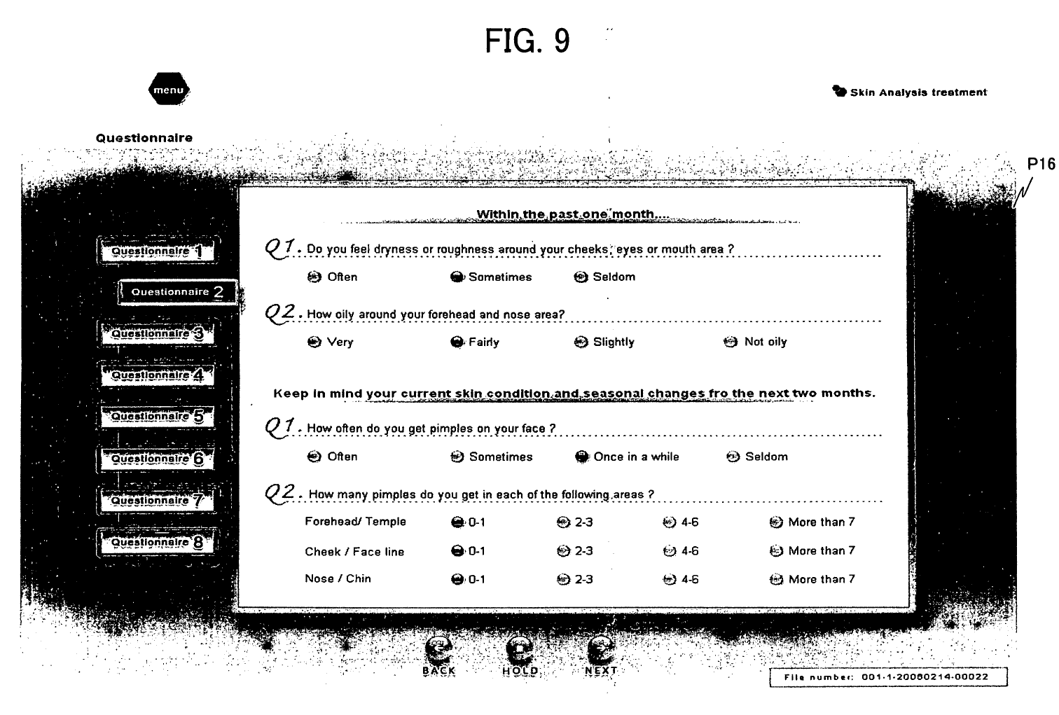

FIG. 9 shows, as an example of a skin questionnaire screen, a display example of the screen P16 (Questionnaire One: Common Questionnaire One). On the screen P16, four questions are presented and up through four answer options are prepared for each of the questions.

The questions Q1 and Q2 are questions about the oiliness (sebum) of skin, and answers to the questions Q1 and Q2 influence the evaluation result of the evaluation item “oiliness (sebum)”. The other questions Q1 and Q2 are questions about the skin's proneness to acne (pimples), and answers to the other questions Q1 and Q2 influence the evaluation result of the evaluation item “susceptibility to pimples”. As a screen shift request is entered after inputting answers on the screen P16 is finished, the screen P16 is replaced with the screen P17.

The screen P17 (Questionnaire Two: Common Questionnaire Two) presents plural questions about the skin's “sensitivity” and answer options to each question. Answers to the questionnaire on the screen P17 influence the evaluation results of the evaluation items “sensitivity” and “sensitivity/factors”. As a screen shift request is entered after inputting answers on the screen P17 is finished, the screen P17 is replaced with the screen P18.

The screen P18 (Questionnaire Three: Common Questionnaire Three) presents one or more questions about the skin's moisture content, oil content, and elasticity, and answer options to each question. The screen P18 may be constructed such that answers to the questionnaire on the screen P18 influence the evaluation results of the evaluation items “hydration retaining ability” and “oiliness”, for example. As a screen shift request is entered after inputting answers on the screen P18 is finished, the screen P18 is replaced with the screen P19.

The screen P19 (Questionnaire Four: Common Questionnaire Four) prompts the customer to choose only one item out of plural skin trouble items (“skin dryness/skin roughness”, “wrinkles”, “oiliness”, and the like) prepared. As a screen shift request is entered after a skin trouble is chosen and entered on the screen P19, the screen P19 is replaced with the screen P20. The skin trouble chosen is taken into account in creating an aesthetic treatment recipe.

The screen P20 (Questionnaire Five: Aesthetic Treatment Questionnaire One) presents questions about the skin's oiliness, dryness, and roughness as to today's skin condition and answer options to each question. Answers to the questions are taken into account in creating an aesthetic treatment recipe. As a screen shift request is entered after inputting answers on the screen P20 is finished, the screen P20 is replaced with the screen P21.

The screen P21 (Questionnaire Six: Aesthetic Treatment Questionnaire Two) presents options representing types of skin desired by customers, and prompts a customer to choose a given number of options (for example, three) out of the presented options in decreasing preference order. Answers are taken into account in creating an aesthetic treatment recipe. As a screen shift request is entered after inputting answers on the screen P21 is finished, the screen P21 is replaced with the screen P22.

The screen P22 (Questionnaire Seven: Aesthetic Treatment Questionnaire Three) presents options representing living habits, and prompts a customer to choose an option that matches the customer's living habit of late. Plural options may be chosen at once, or an option indicating that there are no living habits that fit may be chosen in case none of the presented options fits. The screen P22 also presents plural options representing physical conditions, and prompts the customer to choose an option that describes the customer's physical condition. Plural options may be chosen at once, or an option indicating that there are no physical conditions that fit may be chosen. Answers entered on the screen P22 are taken into account in creating an aesthetic treatment recipe. As a screen shift request is entered after inputting answers on the screen P22 is finished, the screen P22 is replaced with a screen P23.

The screen P23 is an evaluation result waiting screen, which informs that evaluation processing is underway. While the screen P23 is displayed, the server 41 performs processing of calculating analysis results based on the horny layer images, the texture image, and the discoloration image, and evaluation results based on answers to the skin questionnaire.

The server 41 also executes processing of creating skin care advice based on at least the evaluation results. In this processing, the CPU 401 uses given logic to select, from the evaluation results, an evaluation item that particularly needs care. Then a description (text data, stored in advance in the screen data DB 4052) of care suitable for the selected item is determined as a part of screen data.

Also executed in the server 41 is processing of creating an aesthetic treatment recipe based on the evaluation results and answers to Aesthetic Treatment Questionnaires One to Three. The aesthetic treatment recipe creating processing is performed when the CPU 401 of the server 41 executes a program, for example, as follows:

The HD within the HDD 405 of the server 41 stores an aesthetic treatment recipe DB 4054 (hereinafter referred to as recipe DB 4054). The recipe DB 4054 has a table holding data of aesthetic treatment recipes associated with combinations of numerical values that are calculated as evaluation results of evaluation items through evaluation processing and patterns of answers to Aesthetic Treatment Questionnaires One to Three.

The CPU 401 reads, out of the table (recipe DB 4054) data of an aesthetic treatment recipe that is associated with the numerical values calculated as evaluation results and the answer patterns. The read data is determined as an aesthetic treatment recipe that is to be proposed to the customer.

After the evaluation result calculating processing, the skin care advice creating processing, and the aesthetic treatment recipe creating processing are finished, the server 41 creates screen data for presenting the evaluation results, the skin care advice, and the aesthetic treatment recipe. The created screen data is provided to the PC 21.

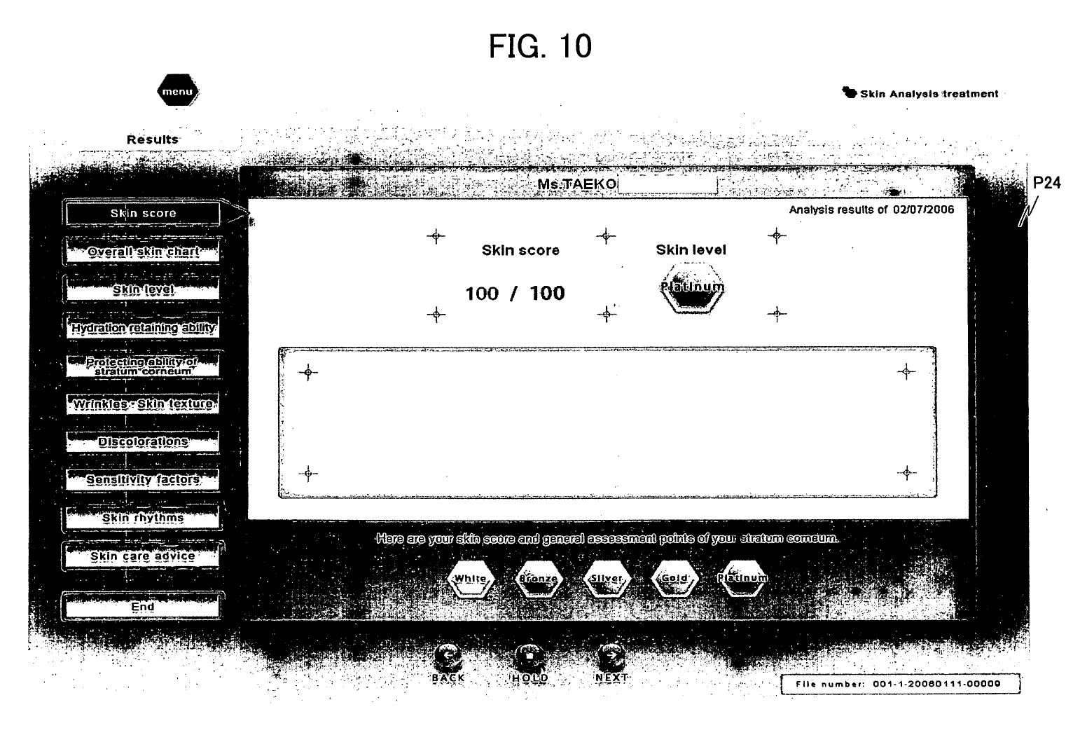

As the server 41 notifies the PC 21 of completion of the evaluation processing, the screen P23 is replaced with a screen 24. The screen 24 is, as shown in FIG. 10, a “skin score” displaying screen. The screen P24 displays a numerical value of “skin score” rated out of 100 points, a skin level (calculated on the server 41 from the evaluation results) out of five levels, “White”, “Bronze”, “Silver”, “Gold” and “Platinum”, and comments suited to the skin score and the skin level.

The screen P24 and screens P25 to P33 have common buttons, which are located on the left hand side of the screens and allow a jump to the screens P24 to P33. The lower part of each of the screens P24 to P33 has a “NEXT” button and a “BACK” button. The press of the “NEXT” button advances the display device to the next screen and the press of the “BACK” button brings the display device back to the preceding screen.

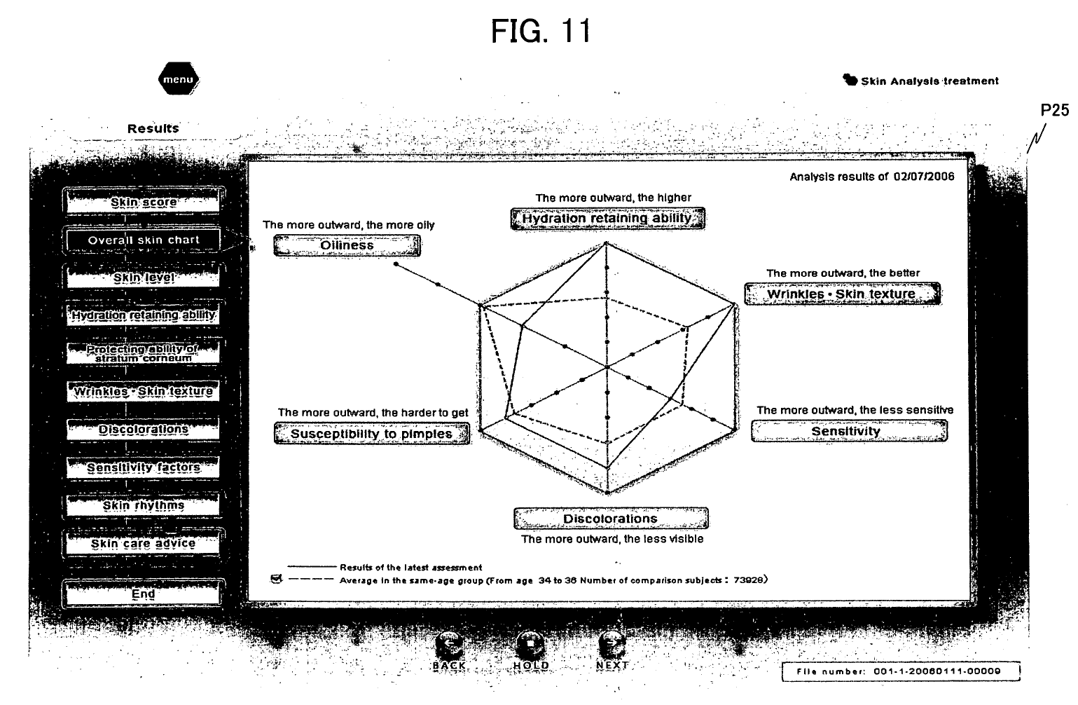

The screen P25 displays a customer's “Overall skin chart” as the one shown in a display example of FIG. 11. The Overall skin chart shows an evaluation of a customer made in five levels on each of five items, “hydration retaining ability”, “oiliness”, “susceptibility to pimples”, “discolorations”, “wrinkles/skin texture” and “sensitivity”. The Overall skin chart shows, as a comparison, the mean values (average) of Japanese people or American people (specified by the choice of language) of the customer's age.

The screen P26 displays a customer's “skin level”. The screen P26 employs a histogram to show the distribution of people of the customer's age among the five skin levels mentioned above, and a bar representing the level to which the customer belongs is displayed in a manner different from other levels (for example, in a different color). This enables the customer to see where he/she ranks among people of his/her age.

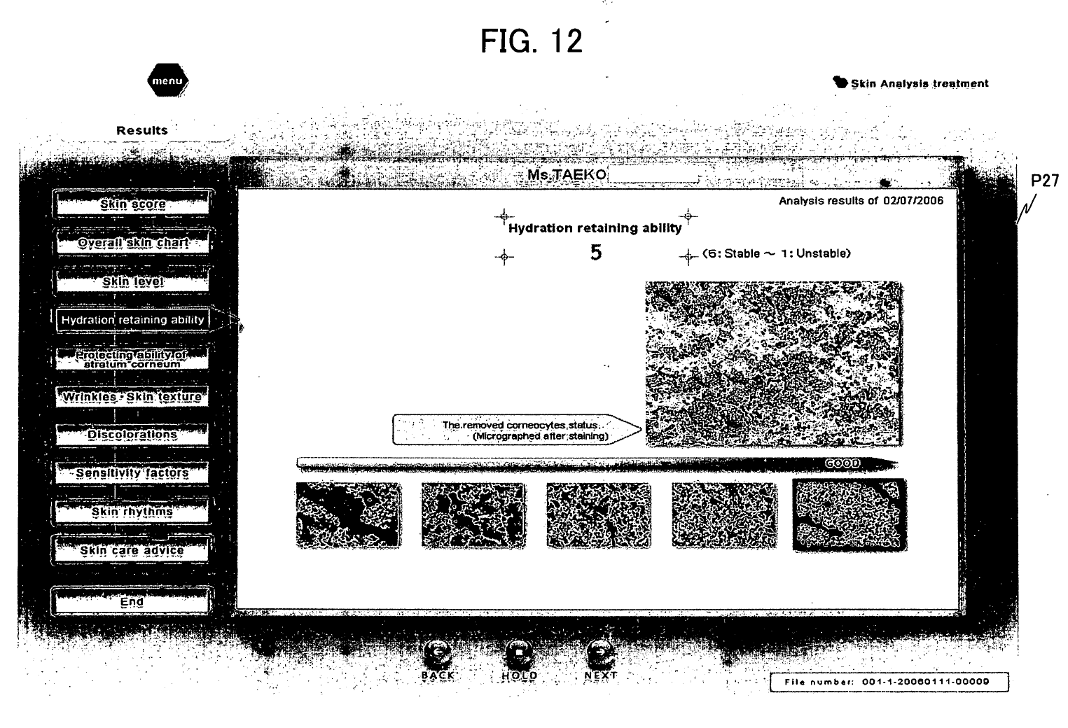

The screen P27 displays a customer's evaluation result about “hydration retaining ability”. The screen P27 displays, as shown in a display example of FIG. 12, a numerical value indicating the evaluation result of the way horny layer cells (corneocytes) peel (TA) (evaluated in five levels). The corneocyte image (TA) on which the evaluation has been made, and comments determined in accordance with the numerical value of the evaluation result are also displayed.

The screen P27 also displays five corneocyte sample images representing five evaluation levels, and one of the sample images that corresponds to the customer's level is displayed in a manner different from other sample images (here, the corresponding sample image is edged with a color frame). A general explanation about the relation between the water retention ability and the way the corneocyte peels is also displayed.

The screen P28 displays a customer's evaluation result about “protecting ability of stratum corneum”. The screen P28 displays a numerical value indicating the evaluation result of the degree of completion of the horny layer (evaluated in five levels). The horny layer (stratum corneum) image (degree of completion) on which the evaluation has been made, comments determined in accordance with the numerical value of the evaluation result, and the like are also displayed.

The screen P29 displays a customer s evaluation result about “wrinkles/skin texture”. The screen P29 displays a numerical value indicating the result of the skin delicacy evaluation based on a texture image (evaluated in five levels). The texture image on which the evaluation has been made, comments determined in accordance with the numerical value of the evaluation result, and the like are also displayed.

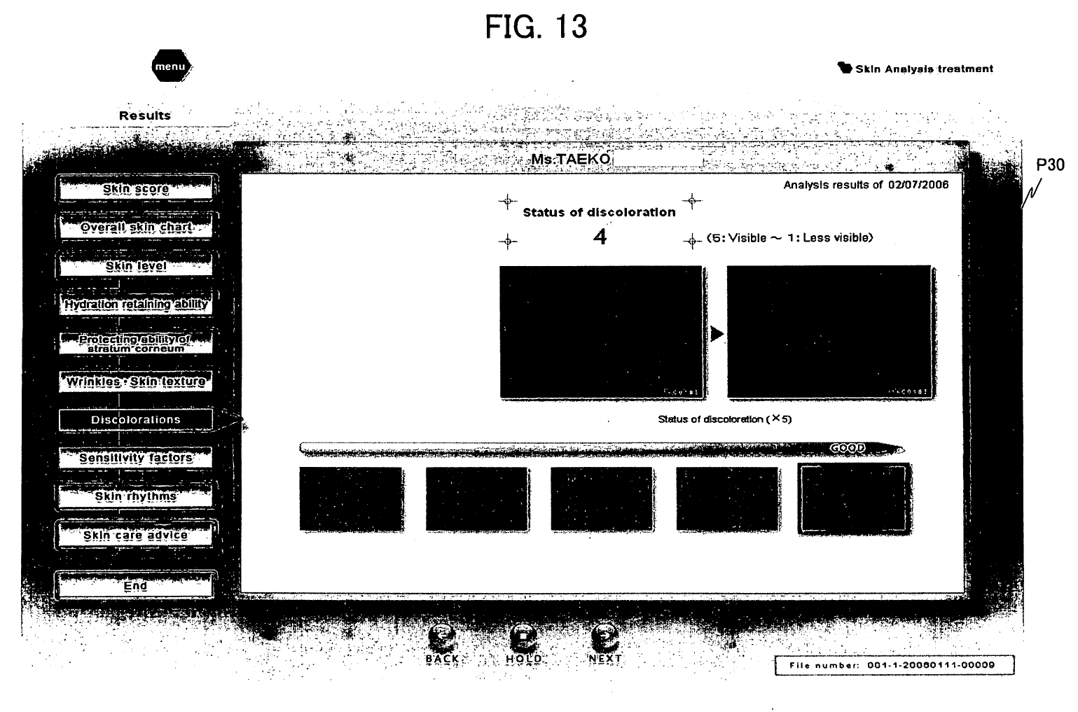

The screen P30 displays a customer's evaluation result about “discoloration”. The screen P30 displays, as shown in a display example of FIG. 13, a numerical value indicating the result of the skin discoloration evaluation based on a discoloration image (evaluated in five levels). The discoloration image on which the evaluation has been made (the original image on the left hand side), the B channel image (on the right hand side), comments determined in accordance with the numerical value of the evaluation result, and the like are also displayed.

The screen P30 also displays five discoloration image sample images representing five evaluation levels, and one of the sample images that corresponds to the customer's level is displayed in a manner different from other sample images (here, the corresponding sample image is edged with a color frame). A general explanation about discoloration is also displayed.

The screen P31 displays a customer's evaluation result about “sensitivity/factors”. The screen P31 displays the customer's levels of “protecting ability of horny layer”, “resistance against chemical stimuli”, “resistance against physical stimuli” and “resistance against UV rays”, and the mean values of people of the customer's age.

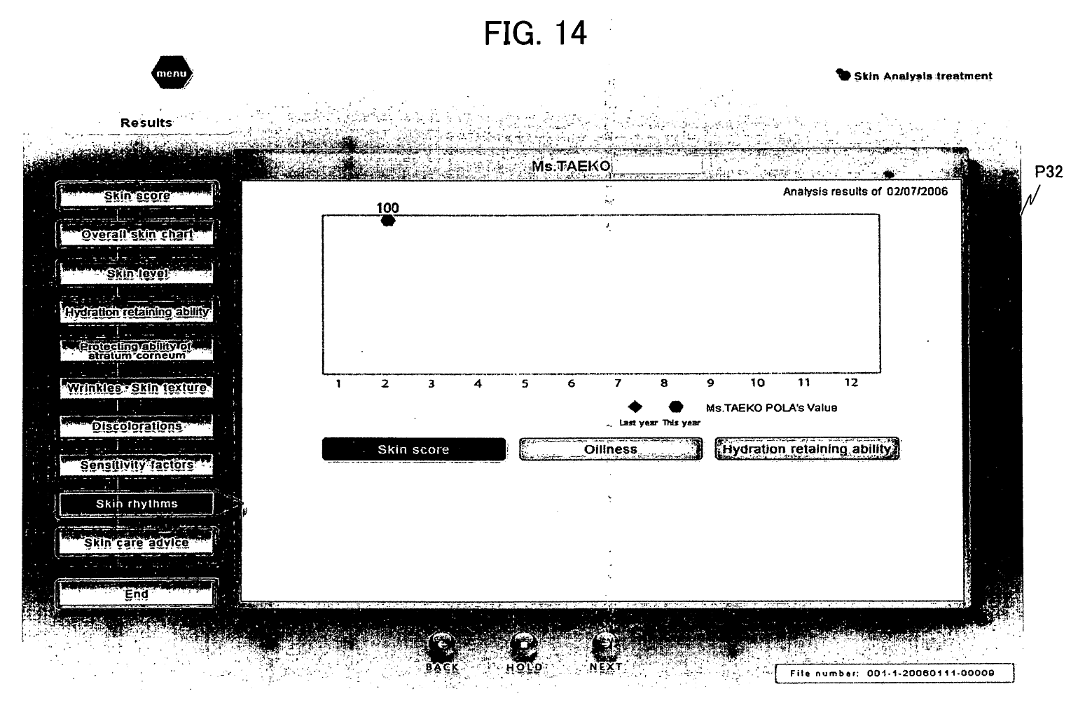

The screen P32 shows a customer's “skin rhythms”. The screen P32 displays, as shown in a display example of FIG. 14, a year-round graph and the mean value of people of the customer's age with a curve. The customer's evaluation result of this time is plotted onto the graph. In FIG. 14, the customer's “skin score” of this time is plotted.

The screen P32 is provided with buttons for switching between “skin score”, “oiliness” and “hydration retaining ability”. The switching buttons switch mean value curves and plot positions displayed on the graph. If a customer repeatedly receives the skin analysis (skin check) throughout a year, plots are connected to each other and a graph showing year-round values of the customer's skin is created.

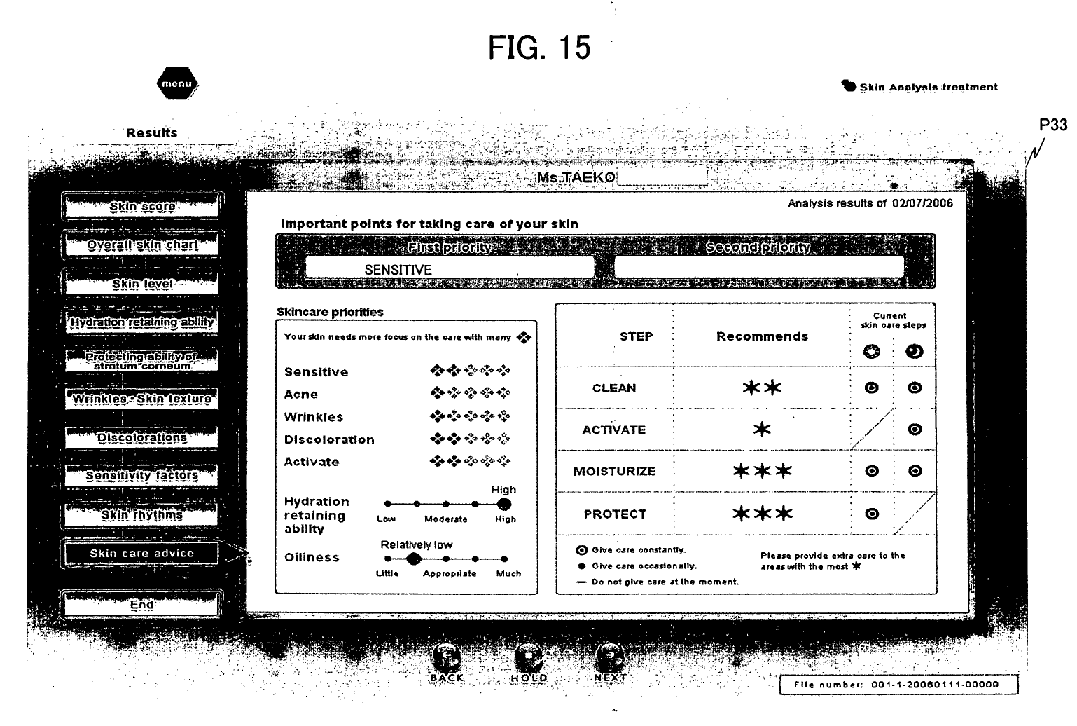

The screen P33 shows “skin care advice” to a customer. The screen P33 displays, as shown in a display example of FIG. 15, care points on which emphasis is to be placed and marks on plural care items. Recommended makeup steps are also displayed on the screen P33.

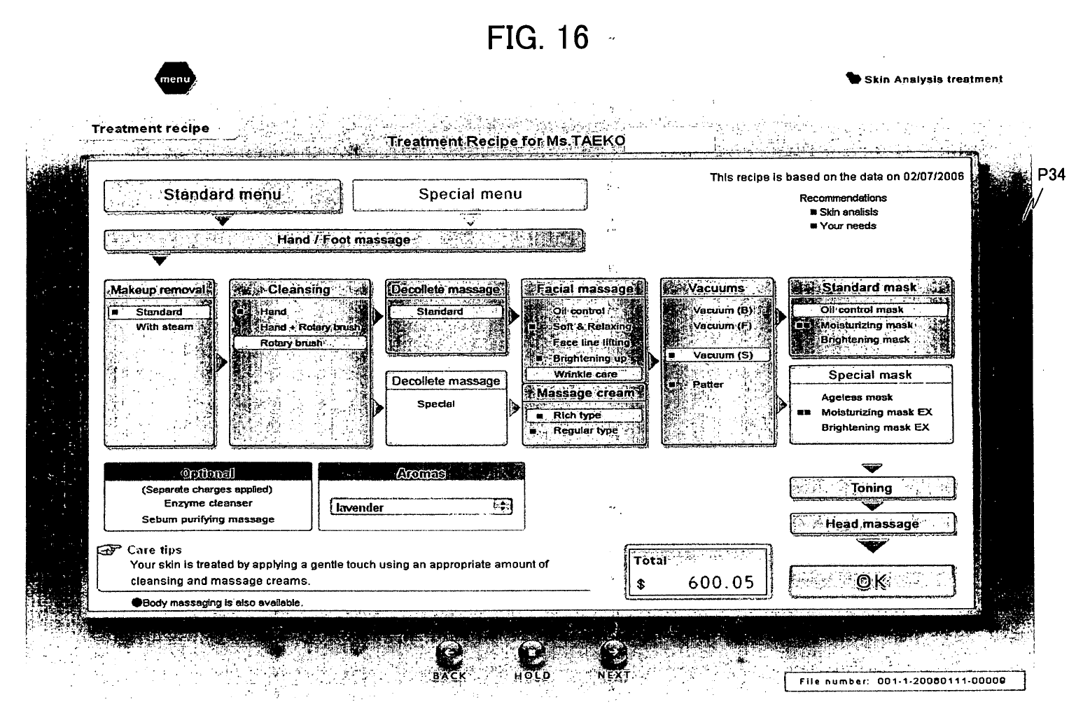

A salesclerk gives a verbal explanation on the results to a customer using the screens P24 to P33. Thereafter, the display device 204 displays a screen P34, which displays an aesthetic treatment recipe suited to counseling and skin check results as the one shown in a display example of FIG. 16. In the case where the customer consents to the recipe presented on the screen P34, an OK button on the screen P34 is pressed.

Then the screen P34 is replaced with a screen P35, which indicates the end of counseling. The screen P35 has a button for printing an aesthetic treatment carte, which is managed by the salon, and an aesthetic treatment recipe (the recipe displayed on the screen P34) as well as a skin care advice sheet (the care advice displayed on the screen P33), which are handed to the customer. With the press of the print button, the printer 32 prints out the carte, the recipe, and the advice sheet.

When the printing is finished, the screen returns to the screen P2, whereby ending counseling. Then the customer actually receives aesthetic treatment following the aesthetic treatment recipe. The customer's skin can thus be improved.

<<Second or Subsequent Visit (Revisit)>>

When it is a customer's second or subsequent visit, “second time or more (revisit)” is chosen on the screen P2 shown in FIG. 3 and a language is chosen on the screen P3 during counseling of the customer. Thereafter, the counseling proceeds to processing shown in FIG. 4.

As shown in FIG. 4, choosing a language on the screen P3 causes a shift to the screen P10. Since personal information of the customer has previously been registered here, the personal information is loaded onto the screen P10 from the server 41 using the customer s assigned customer ID or the customer's name and birth date. Whether the loaded customer information is up to date or not is checked and, when it is confirmed that the customer information is up to date, a screen shift takes place.

The same processing as the first time visit is executed on the screen P11. The screen P12 (FIG. 8) is displayed next. Which aesthetic treatment course the customer receives this time is selected on the screen P12. In the case where the “skin analysis treatment” course is chosen, the screen turns into the screen P13. In the case where the “self-select (consultation) treatment” course (simple course) is chosen, the screen turns into the screen P12-1, and the simple aesthetic treatment course is implemented.

A taboo check is conducted on the screen P13 as in the first visit and, when it is checked OK, the screen turns into a screen P36. The screen P36 has a field to enter whether the last aesthetic treatment has caused a skin trouble and, if it has, specifics of the trouble.

Trouble specifics entered on the screen P36 are written in, for example, an aesthetic treatment carte which is printed at the end of counseling. On the screen P36, the customer is asked whether to omit the skin check (P14, P15) prior to receiving aesthetic treatment this time. In the case where the customer chooses not to omit a skin analysis, the skin analysis (P14, P15) is conducted, the customer answers the questionnaires (P16 to P22), and counseling proceeds to the evaluation processing (P23). In the case where the customer chooses to omit the skin analysis, the customer answers the questionnaires and the counseling proceeds to the evaluation processing (P23).

In the case where no trouble has been caused, the screen P36 is replaced with a screen P37. The screen P37 displays the aesthetic treatment recipe of the last time, and asks for confirmation from the customer. The screen P37 also demands an answer about whether to accept the skin analysis and questionnaires this time (omission/execution of skin analysis and questionnaires).

In the case where the customer chooses omission (in the case the customer receives treatment without skin evaluation), the screen turns into the screen P24. The screen P24 displays the last evaluation results (P24 to P33), and aesthetic treatment is performed following the aesthetic treatment recipe of the last time.

In the case where the customer chooses execution, the skin analysis (p14, P15) is conducted, the questionnaires (P16 to P22) are answered, and the counseling proceeds to the evaluation processing (P23). Then, skin evaluation results based on the skin analysis and questionnaires of this time are presented to the customer on the screens P24 to P33. The screens P24 to P33 may simultaneously display past (e.g., the last time and the second to the last time) evaluation results, so that the customer can make a comparison. A rise of a numeric value (evaluation score) for an evaluation item lets the customer see an improvement in skin condition objectively.

Thereafter, an aesthetic treatment recipe suited to the evaluation results of this time is presented to the customer on the screen P34. With consent from the customer, the recipe is printed and aesthetic treatment following the recipe is performed. If a customer chooses the “skin analysis treatment” course at every visit as this, skin evaluation results based on a skin analysis and answers to questionnaires are presented to the customer, an aesthetic treatment recipe suited to the evaluation results is created, and aesthetic treatment is performed following the recipe. The customer can thus improve his/her skin.

<Merchandise Store>

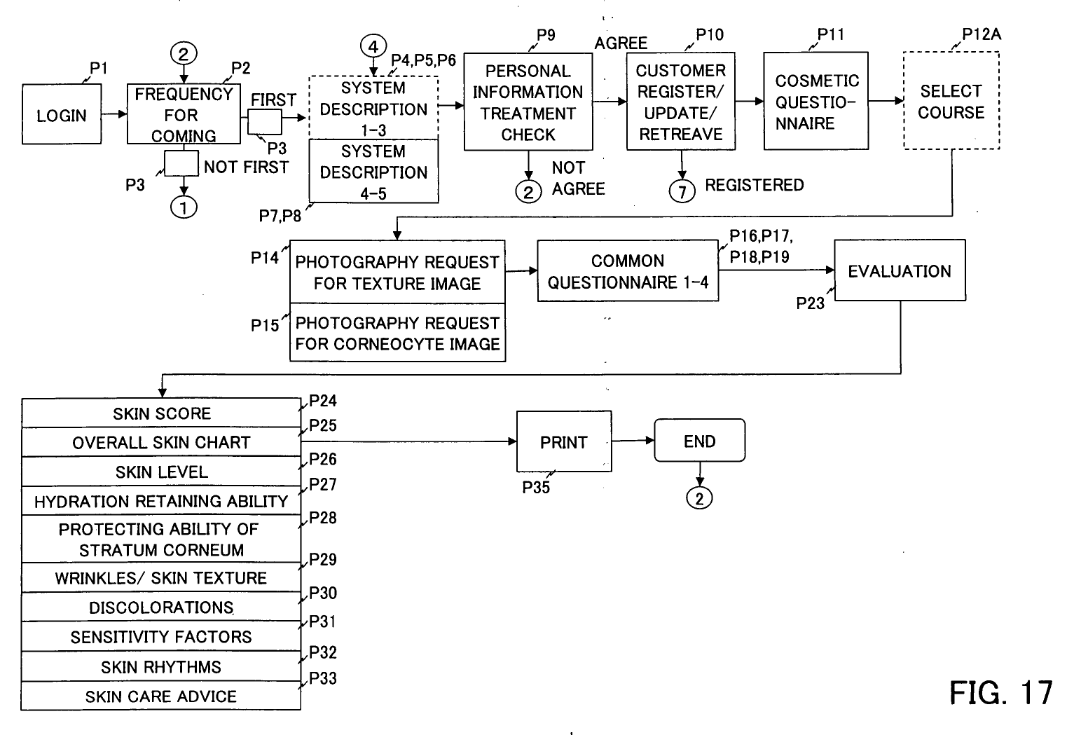

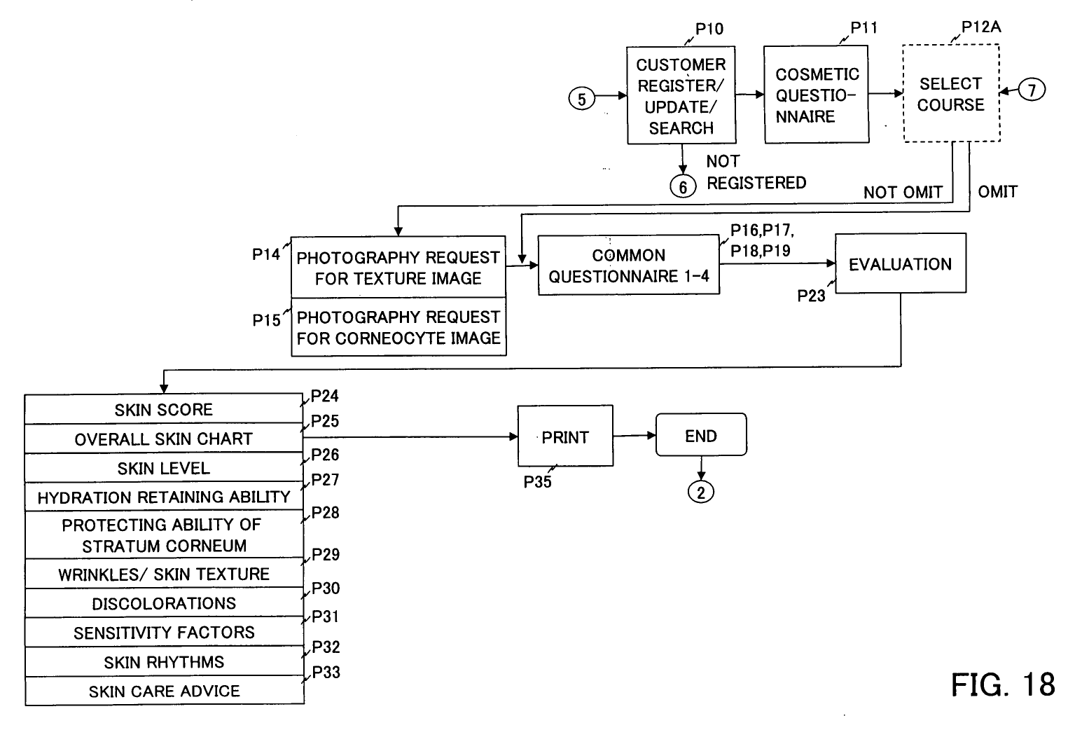

FIG. 17 is a screen transition diagram of screens presented to a customer who visits the merchandise store for the first time. FIG. 18 is a screen transition diagram of screens presented to a customer on his/her second or subsequent visit to the merchandise store. The screens are displayed on the display screen of the display device 204 of the PC 11.

Screens presented at the merchandise store are basically the same as the ones presented at the aesthetic treatment salon, but are masked (omitted) in portions that are not needed at the merchandise store. Out of the screens shown in FIGS. 17 and 18, those that have the same symbols as the screens shown in FIGS. 3 and 4 are the same as the screens displayed at the aesthetic treatment salon (on the PC 21), and detailed descriptions thereof will therefore be omitted here. The PC 11 performs the same processing as the PC 21 to obtain and display image data.

<<First Visit>>

In the screen transition diagram shown in FIG. 17, steps related to the screens P1 to P11 are identical with those in the screen transition (FIG. 3) at the aesthetic treatment salon. When the step of the screen P11 is ended, the screen turns into a screen P12A.

The screen P12A asks a customer to choose from a first course in which a skin check is conducted and a questionnaire is answered and a second course in which a questionnaire is answered but a skin check is omitted. However, a first time customer is asked to choose the first course. Then the screen P12A is replaced with the screen P14 to conduct a skin check (image shooting, P14 and P15) and a questionnaire is answered. The screens P20 to P22 which display the aesthetic treatment-specific questionnaires are not displayed.

Thus, in the merchandise store too, a skin check is conducted and a questionnaire is answered (P14 to P19), the skin is evaluated (P23) based on the skin check and the answers to the questionnaire, and evaluation results are presented (P24 to P33) as in the aesthetic treatment salon.

On the screen P 35, a home care advice sheet is printed and presented to the customer. Thereafter, the customer may purchase cosmetics suggested by a salesclerk in accordance with the evaluation results and the contents of the home care advice sheet. The customer can improve his/her skin by using the cosmetics.

In the screen transition diagram mentioned above, displaying the screens P4 to P8 (system description) lets the customer know what kind of aesthetic treatment is provided at the aesthetic treatment salon. This can motivate the customer to receive aesthetic treatment.

<<Second or Subsequent Visit (Revisit)>>

As shown in the screen transition diagram of FIG. 18, a customer on his/her second or subsequent visit (revisit) can choose to omit a skin check (P14 and P15) on the screen P12A (choose the second course). In this case, the screen P12A is replaced with the screen P16. However, the screen P12A displays a note of caution urging customers to receive the next skin check within two weeks from the last skin check. This is because making an evaluation on images taken last time is not likely to skew evaluation results much if it is within two weeks since the last time. Sales clerks advise customers to choose the second course only when a skin check has been performed within two weeks back from the current date.

The customer can accept evaluation results of this time with reference to evaluation results on the screens P24 to P33. If an item is evaluated higher than before, the customer can know objectively that the cosmetics have worked. A change in evaluation results causes a change in home care advice (P33). The change can be reflected on cosmetics recommended to the customer by a sales clerk. Thus cosmetics best suited to the current skin condition of a customer are proposed and the customer can improve his/her skin by using the proposed cosmetics.

[Effects of Embodiment]

As has been described, according to the system of the embodiment, the aesthetic treatment salon and the merchandise store evaluate a customer's skin based on a skin check and answers to a questionnaire, and provide home care advice and an aesthetic treatment recipe to the customer in accordance with the evaluation. The customer can improve his/her skin by purchasing cosmetics following the home care advice or by receiving aesthetic treatment following the aesthetic treatment recipe.

A customer's skin images, answers to a questionnaire, and evaluation results are accumulated as customer information in the server 41, so that they can be used in the next presentation of evaluation results. This enables the customer to objectively understand the effects of cosmetics or the effects of aesthetic treatment and see the transition of his/her own skin condition. Customer information gathered in the head office can also be used in development of cosmetics and aesthetic treatment.

[Modification Example]

In the embodiment described above, the server 41 provides screen data to the PCs 11 and 21. Instead of obtaining screen data from the server 41, the PCs 11 and 21 may each store the screen data DB 4052 in the HD of the HDD 206.

Also, the PCs 11 and 21 may each store the evaluation material data DB 4053 and the aesthetic treatment recipe DB 4054 in the HD of the HDD 206 to execute the evaluation processing (P23) inside themselves. In this case, the PC 31 sends results of analyzing the horny layer images, the texture image, and the discoloration image to the PC 11 or the PC 21 that has made the request instead of the server 41.

Furthermore, the PC 11 and the PC 21 may evaluate the texture image and the discoloration image by themselves instead of requesting the PC 31 to make an evaluation. In this case, the server 41 only handles customer information management, and provides customer information upon request from the PCs 11 and 21.

The PCs 11 and 21 may store a local customer DB to manage customer information by synchronizing the local customer DB with the customer DB in the server 41 (the server 54).

Evaluation on horny layer cells' TA and degree of completion and discoloration/texture evaluation which are performed in the PC 31 may be automatically conducted by the CPU. For instance, sample images (see FIGS. 12 and 13) corresponding to the respective evaluation levels may be stored in the HD in advance, the CPU 304 may compare each photographed image with the sample images to specify which of the sample images is closest, and a numerical evaluation value (evaluation score) assigned to this sample image may be determined as the evaluation result.

[Addendum]

The embodiment described above discloses the following invention.

(1) A total beauty management system comprising a shared server for centralized management of customer information of a cosmetics store and customer information of an aesthetic treatment salon, characterized in that the shared server has, as data, for each individual customer, 1) physical quantity data of the customer's skin measured by machines, 2) skin information based on observation results of horny layer cells collected from the customer, 3) skin information obtained from enlarged images of the facial skin, 4) skin condition information based on the customer s own perception, 5) the customer's self-diagnosis information for treatment selection, 6) information on today's skin condition based on the customer's own perception, and 7) treatment preference information.

(2) A total beauty management system according to (1), characterized in that the shared server is connected to a computer in the cosmetics store and to a computer in the aesthetic treatment salon.

(3) A total beauty management system according to (1) or (2), characterized in that data utilized at the cosmetics store comprises 1) physical quantity data of the customer's skin measured by machines, 2) skin information based on observation results of horny layer cells collected from the customer, 3) skin information obtained from enlarged images of the facial skin, and 4) skin condition information based on the customer's own perception.

(4) A total beauty management system according to (1) or (2) characterized in that the aesthetic treatment salon provides, to a first time user, (1) a course in which a treatment method suitable for skin condition improvement is selected and provided based on the user's skin condition evaluated from 1) physical quantity data of the customer's skin measured by machines, 2) skin information based on observation results of horny layer cells collected from the customer, 3) skin information obtained from enlarged images of the facial skin, 4) skin condition information based on the customer's own perception, and 5) the customer's self-diagnosis information for treatment selection, and (2) a course in which a treatment method is selected from the customer's treatment preference information.

(5) A total beauty management system according to (1) or (2) characterized in that, for a user on his/her second or subsequent visit to the aesthetic treatment salon, a treatment method suitable for skin condition improvement is selected based on the user's skin condition evaluated from such data that is obtained by correcting 1) accumulated physical quantity data of the customer's skin measured by machines, 2) skin information based on observation results of horny layer cells collected from the customer, 3) skin information obtained from enlarged images of the facial skin, 4) skin condition information based on the customer's own perception, and 5) the customer's self-diagnosis information for treatment selection with 6) physical quantity data of the customer's skin re-measured by machines at the date of the revisit and 7) information on that day's skin condition based on the customer's own perception.

(6) A total beauty management system according to (1) or (2) characterized in that, in the case where a customer of the cosmetics store receives an aesthetic treatment service at the aesthetic treatment salon for the first time, a treatment method suitable for skin condition improvement is selected based on the user's skin condition evaluated from such data that is obtained by complementing 1) physical quantity data of the customer's skin measured by machines, 2) skin information based on observation results of horny layer cells collected from the customer, 3) skin information obtained from enlarged images of the facial skin, and 4) skin condition information based on the customer s own perception at the cosmetics store with 5) the customer's self-diagnosis information for treatment selection, and by correcting them with 6) physical quantity data of the customer's skin re-measured by machines at the date of the revisit and 7) information on that day's skin condition based on the customer's own perception.

(7) A total beauty management system according to (1) or (2) characterized in that, in the case where a customer of the aesthetic treatment salon purchases cosmetics at the cosmetics store, cosmetics to be purchased are selected based on such data that is obtained by correcting 1) accumulated physical quantity data of the customer's skin measured by machines, 2) skin information based on observation results of horny layer cells collected from the customer, 3) skin information obtained from enlarged images of,the facial skin, 4) skin condition information based on the customer's own perception, and 5) the customer's self-diagnosis information for treatment selection with 6) physical quantity data of the customer's skin re-measured by machines at the date of the revisit and 7) information on that day's skin condition based on the customer's own perception.

(8) A total beauty management system according to any one of (1) to (7), characterized in that the physical quantity of the customer's skin measured by machines is one, or two or more kinds selected from the group consisting of skin moisture content, sebum content, and skin elasticity.

(9) A total beauty management system according to any one of (1) to (8), characterized in that items of observation of the horny layer cells include the shape of a horny layer cell and/or the degree of exfoliation.

(10) A total beauty management system according to any one of (1) to (9), characterized in that items of observation of enlarged images of the facial skin include one, or two or more kinds selected from the group consisting of skin surface irregularity, skin texture, and wrinkle formation.

<Others>

The disclosures of Japanese patent application No. JP2005-111402 filed on Apr. 7, 2005 including the specification, drawings and abstract are incorporated herein by reference.

What is claimed is:

1. A beauty information providing system, comprising:
a first computer used in counseling of a customer who visits a merchandise store to sell goods including cosmetics;
a second computer used in counseling of a customer who visits an aesthetic treatment salon;
a server connected to the first and second computers via communication networks;
evaluation result creating means creating an evaluation result of a customer's skin based on at least results of analysis on images of corneocytes collected from the customer's skin, results of analysis on enlarged images of the customer's skin, and the customer's answers to a skin evaluation questionnaire; and
screen data creating means creating screen data for showing the evaluation results, screen data for showing skin care advice suited to the evaluation results, and screen data for showing an aesthetic treatment recipe suited to the evaluation results,
wherein the first computer has display control means, which displays on a display device screens based on screen data for showing skin evaluation results of a customer who visits the merchandise store and screen data for showing skin care advice, the screen data being created by the screen data creating means,
wherein the second computer has display control means, which displays on a display device screens based on screen data for showing skin evaluation results of a customer who visits the aesthetic treatment salon, screen data for showing skin care advice, and screen data for showing an aesthetic treatment recipe, the screen data being created by the screen data creating means, and
wherein the server has storage means to store a customer database, which holds at least the evaluation results and the aesthetic treatment recipe as items to store.

2. The beauty information providing system according to claim 1, wherein, in the case where past evaluation results of a customer are stored in the customer database, the evaluation result creating means creates, for the customer, skin evaluation results on which the past evaluation results are reflected.

3. The beauty information providing system according to claim 1, further comprising a sales facility, which includes a first area used as the merchandise store, a second area used as the aesthetic treatment salon, and a third area placed between the first area and the second area to be shared between the merchandise store and the aesthetic treatment salon,
wherein the first area and the second area are provided with entrances from the outside that are independent of each other,
wherein the third area is provided with an entrance leading to the first area and an entrance leading to the second area,
wherein the first computer is placed in the first area,
wherein the second computer is placed in the second area, and
wherein a third computer connected to the first and second computers via communication networks are placed in the third area to create image data of corneocytes collected from a customer and analyze the corneocytes based on the image data.

4. The beauty information providing system according to claim 1, wherein the evaluation result creating means and the screen data creating means are placed in the server, and
wherein the server provides the screen data corresponding to a request from the first computer or from the second computer.
